(19) United States
(12) Patent Application Publication
(10) Pub. No.: US 2026/0320415 A1
(43) Pub. Date: Oct. 15, 2026

(54) Hardware-efficient Encoding for Optimization Problems

(71) Applicant: Rigetti & Co, LLC, Berkeley, CA (US)

(72) Inventors: Bhuvanesh Sundar, Ithaca, NY (US); Maxime Dupont, Berkeley, CA (US)

(73) Assignee: Rigetti & Co, LLC, Berkeley, CA (US)

(21) Appl. No.: 19/698,109

(22) Filed: Jun. 4, 2026

Related U.S. Application Data
(63) Continuation of application No. PCT/US2024/035390, filed on Jun. 25, 2024.
(60) Provisional application No. 63/609,220, filed on Dec. 12, 2023.
(60) Provisional application No. 63/613,912, filed on Dec. 22, 2023.

(51) Int. Cl. G06N 5/01; G06N 10/20

(52) U.S. Cl. CPC G06N 5/01; G06N 10/20

(57) ABSTRACT

In a general aspect, hardware-efficient encoding schemes for optimization problems are presented. In some cases, a quantum computing method includes associating subsets of qubits including data qubits and label qubits with clusters of variables in an optimization problem; and mapping the variables in each cluster to the data qubits associated with the cluster, such that multiple variables are mapped to each of the data qubits. During mapping basis states of the label qubits associated with the cluster are identified; the cluster is divided into groups of variables, each group of variables being associated with a respective one of the basis states; and for each group of variables, each variable in the group is mapped to a respective one of the data qubits associated with the cluster. The method further includes causing a quantum processing unit to execute multiple iterations of a quantum program and generating a solution to the optimization problem based on processed measurements.

### CROSS-REFERENCE TO RELATED APPLICATIONS

This application claims priority to U.S. Provisional Patent Application No. 63/609,220, filed Dec. 12, 2023, entitled “Hardware-efficient Encoding for Optimization Problems;” and U.S. Provisional Patent Application No. 63/613,912, filed Dec. 22, 2023, entitled “Hardware-efficient Encoding for Optimization Problems.” The above-referenced priority documents are incorporated herein by reference.

### GOVERNMENT SUPPORT

This disclosure includes one or more inventions made with U.S. Government support under Agreement Nos. HR00112090058 and HR00112330015 awarded by Defense Advanced Research Projects Agency. The U.S. Government has certain rights in these inventions.

### TECHNICAL FIELD

The following description relates generally to hardware-efficient encoding for optimization problems.

### BACKGROUND

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting circuits, trapped ions, spin systems, and others.

### BRIEF DESCRIPTION OF THE DRAWINGS

FIG. 1 is a block diagram of an example computing environment.

FIG. 2 is a schematic diagram showing aspects of an example encoding scheme.

FIG. 3 is a block diagram showing aspects of an example quantum logic circuit.

FIG. 4 is a plot showing the average correlation matrix as a function of qubit number based on the encoding scheme shown in FIG. 2.

FIG. 5A is a schematic diagram showing aspects of an example encoding scheme.

FIG. 5B is a block diagram showing aspects of an example quantum logic circuit.

FIG. 5C is a schematic diagram showing aspects of an example encoding scheme.

FIG. 5D is a block diagram showing aspects of an example quantum logic circuit.

FIG. 6 is a schematic diagram showing aspects of an example encoding scheme.

FIG. 7 is a plot showing the average correlation matrix as a function of qubit number based on the encoding scheme shown in FIG. 6.

FIG. 8A is a schematic diagram showing aspects of an example encoding scheme.

FIG. 8B is a block diagram showing aspects of an example quantum logic circuit.

FIG. 9 is a flow chart showing aspects of an example process.

FIG. 10 is a block diagram showing aspects of an example quantum logic circuit.

FIG. 11 is a flow chart showing aspects of an example process.

FIG. 12 is a plot showing the average approximation ratio (r) as a function of the number (p) of layers of the circuit portion in the quantum logic circuit shown in FIG. 10.

FIG. 13 is a plot showing the approximation ratio as a function of the number of layers (p) of the circuit portion in the quantum logic circuit shown in FIG. 10.

### DETAILED DESCRIPTION

Combinatorial optimization problems are a class of problems that are some of the most popular classical problems being tackled by quantum computers worldwide, since they form the basis for many real-world problems including portfolio optimization, scheduling applications, and resource allocation. The above real-world problems have commercial value. For example, a bank or a hedge fund may want to use a quantum computer to optimize their customers' portfolios, and a job shop may want to use a quantum computer to optimally schedule jobs.

In some aspects of what is described here, encoding schemes to represent optimization problems are presented. The problem encoding schemes can generate variable quantum states that encode a probability distribution over all classical solutions. In some instances, the problem encoding schemes presented here utilize log₂(N/d) label qubits and d data qubits for a total number of q=d+log₂(N/d) qubits to represent an optimization problem with N classical variables. In some cases, the N variables are divided into N/d groups, each of which includes d variables. In some instances, problem encoding schemes utilize entanglement among the qubits.

In some instances, problem encoding schemes utilize

$$n {log}_{2} ( \frac{N}{n} / d )$$

label qubits and nd data qubits for a total number of

$$q = n [ d + {log}_{2} ( \frac{N}{n} / d ) ]$$

qubits to represent an optimization problem with N classical variables which are divided into n clusters; and each cluster includes N/n variables. The N/n variables in a cluster can be further divided into

$$\frac{N}{n} / d$$

groups, each of which includes d variables. In some instances, problem encoding schemes utilize entanglement only among qubits within the same cluster.

In some implementations, the systems and techniques described here can provide technical advantages and improvements. The systems and techniques presented here may implement encoding schemes and a corresponding parameterized quantum circuit to solve combinatorial optimization problems that have a quadratic objective function using a much smaller number of qubits to represent the classical variables. In other words, the number of qubits and thus the number of qubit devices needed to solve an optimization task can be greatly reduced, for example, relative to conventional schemes. Thus, the methods and techniques presented here can be hardware efficient; and can reduce engineering overhead of scaling up quantum hardware. The methods and techniques presented here may increase the size of computational tasks that can be executed by limited quantum resources. In some cases, a combination of these and potentially other advantages and improvements may be obtained.

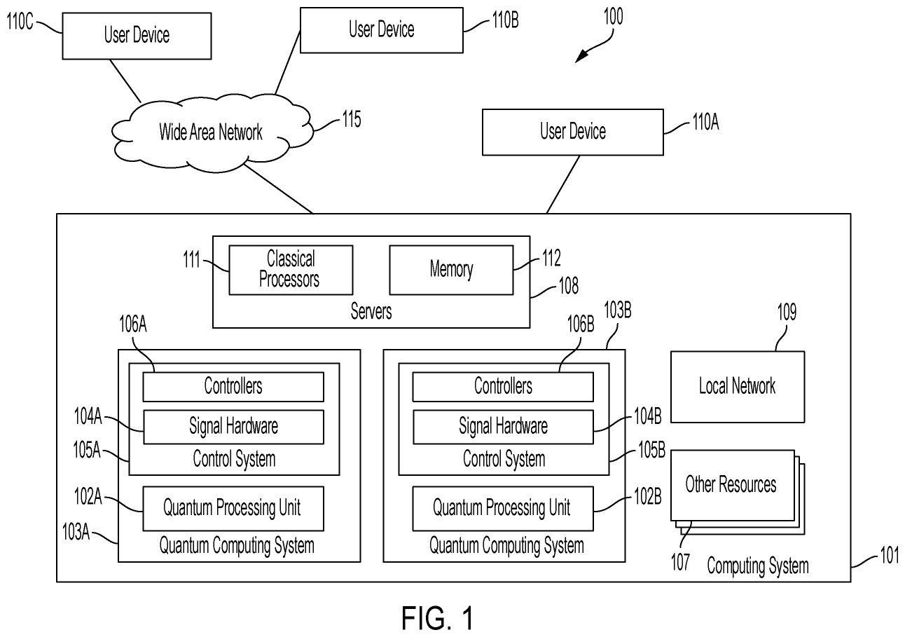

FIG. 1 is a block diagram of an example computing environment 100, according to an example embodiment. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B, and the other resources 107 may communicate with each other through the local network 109. In some implementations, the local network 109 operates as a communication channel that provides one or more low-latency communication pathways from the server 108 to the quantum computing systems 103A, 103B (or to one or more of the elements of the quantum computing systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remotely from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv: 1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format. In some cases, a program may utilize Quil-T, described in the publication “Gain deeper control of Rigetti quantum processing units with Quil-T,” available at https://medium.com/rigetti/gain-deeper-control-of-rigetti-quantum-processors-with-quil-t-ea8945061e5b dated Dec. 10, 2020, which is hereby incorporated by reference in the present disclosure.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing system 101 operates as a hybrid computing environment. For example, quantum programs can be formatted as hybrid classical/quantum programs that include instructions for execution by one or more quantum computing resources (e.g., the quantum-based algorithms) and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors.

In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting codes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

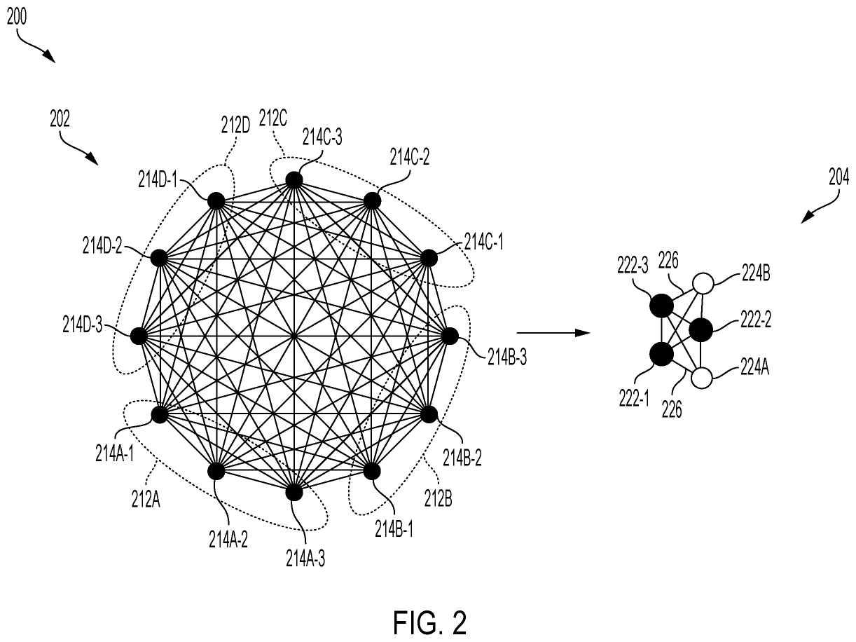

In some instances, all or part of the quantum processing unit 102A functions as a quantum processing unit, a quantum memory, or another type of subsystem. In some examples, the quantum processing unit 102A includes a superconducting quantum circuit system. The superconducting quantum circuit may include data qubit devices, stabilizer qubit devices, coupler devices, readout devices, and possibly other devices that are used to store and process quantum information. In some cases, multiple data qubit devices are operatively coupled to a single stabilizer check qubit device through respective coupler devices. In some implementations, the quantum processing unit 102A is implemented utilizing aspects designed or generated from the components and processes shown in FIGS. 2-4, or in another manner. In certain examples, the qubit devices and the coupler devices are implemented as superconducting quantum circuit devices that include Josephson junctions, for example, in Superconducting QUantum Interference Device (SQUID) loops or other arrangements, and are controlled by radio-frequency signals, microwave signals, and bias signals delivered to the quantum processing unit 102A.

In some instances, the quantum processing modules can include a superconducting quantum circuit that includes one or more quantum circuit devices. For instance, a superconducting quantum circuit may include qubit devices, readout resonator devices, Josephson junctions, or other quantum circuit devices. In some implementations, quantum circuit devices in a quantum processing unit can be collectively operated to define a single logical qubit. A logical qubit includes a quantum register, for instance multiple physical qubits or qudits, and associated circuitry, that supports physical operations which can be used to detect or correct errors associated with logical states in a quantum algorithm. Physical operations supported by the quantum register associated with a logical qubit may include single-qubit or multi-qubit quantum logic gates and readout mechanisms. Error detection or correction mechanisms associated with a logical qubit may be based on quantum error correction schemes such as the surface code, color code, Bacon-Shor codes, low-density parity check codes (LDPC), some combination of these, or others.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computing system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radiofrequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radiofrequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control the operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bit string representing qubit state measurements for a single execution of the quantum program, and a collection of bit strings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computing system 103B and its components (e.g., the quantum processing unit 102B, the signal hardware 104B, and controllers 106B) can be implemented as described above with respect to the quantum computing system 103A; in some cases, the quantum computing system 103B and its components may be implemented or may operate in another manner.

In some implementations, the quantum computing systems 103A, 103B are disparate systems that provide distinct modalities of quantum computation. For example, the computer system 101 may include both an adiabatic quantum computing system and a gate-based quantum computer system. As another example, the computer system 101 may include a superconducting circuit-based quantum computing system and an ion trap-based quantum computer system. In such cases, the computer system 101 may utilize each quantum computing system according to the type of quantum program that is being executed, according to availability or capacity, or based on other considerations.

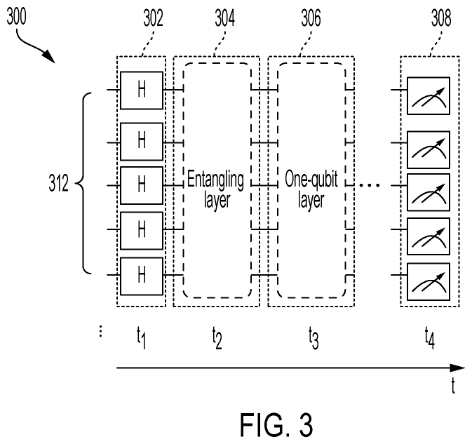

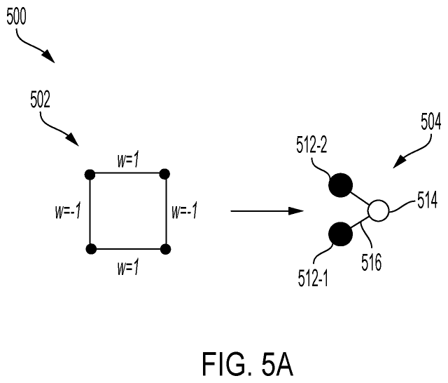

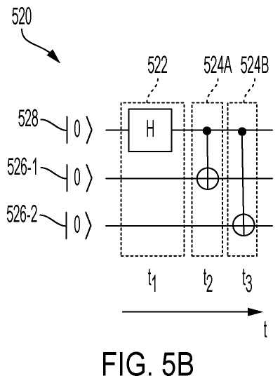

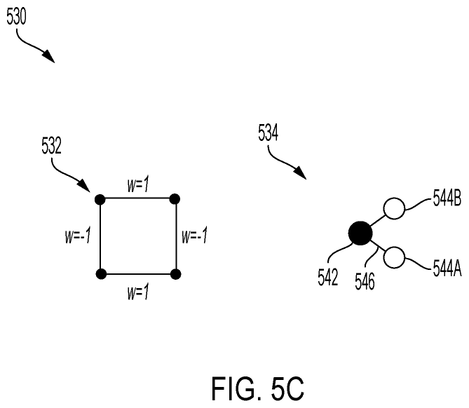

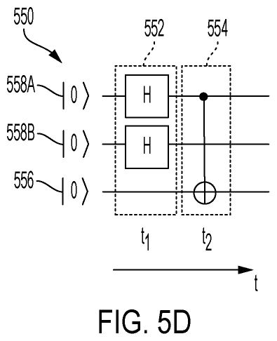

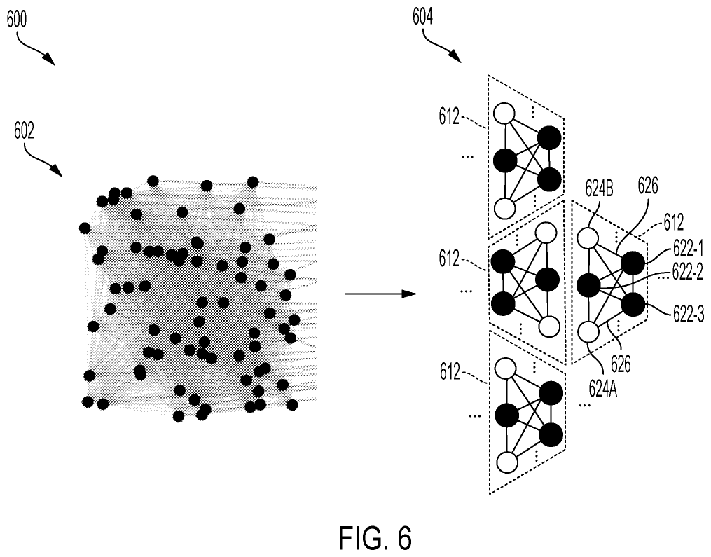

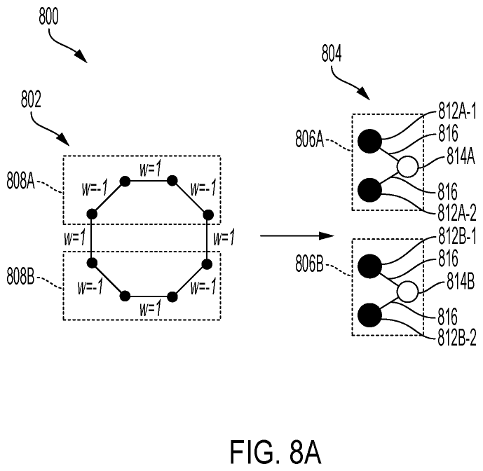

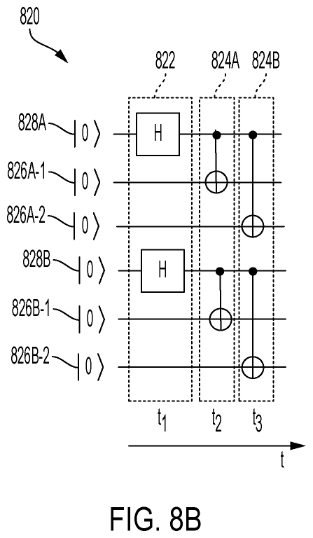

In some instances, one or more components of the computing system 101 shown in FIG. 1 are configured to perform the operations of the example processes 200, 300 in FIGS. 2-3, or another process. For example, a classical computing system (e.g., the classical processors 111 in the servers 108) can be configured to determine a modified quantum logic circuit 600 shown in FIG. 6 based on a quantum logic circuit 500 shown in FIG. 5; and request the quantum computing systems 103A, 103B to executing the modified quantum logic circuits 520, 530, 550, 820 in FIGS. 5B-5D, 8B; and perform measurement on each of the data qubits and label qubits to determine a bit string. In some instances, the components of the computing system 101 may be configured to perform other operations.

In some implementations, the computing system 101 may be configured to iteratively: perform a hardware-efficient encoding scheme to encode classical variables of an optimization problem into qubits; apply a parametric quantum logic circuit on the qubits; evaluate a cost function based on output quantum states from measurements of the qubits; and determine updated parameters of the parametric quantum logic circuit. The hardware-efficient encoding scheme may be implemented as the mapping and encoding algorithm shown in FIGS. 2, 5A, 5C, 6, 8A or in another manner. The computing system 101 may construct a variational quantum algorithm which includes a pure quantum or a hybrid quantum-classical loop to solve an optimization task. The variational quantum algorithm can be performed in a computer system having shared quantum-classical memory for performing an iterative parameter search. For example, the variational quantum algorithm may be performed in the quantum computing system 103 in FIG. 1 or in another type of hybrid computing system.

FIG. 2 is a schematic diagram showing aspects of an example encoding scheme 200. The example encoding scheme 200 maps classical variables of an optimization problem onto qubits defined by qubit devices of a quantum processing unit. In some instances, the optimization problem may include scheduling problems such as the traveling salesman problem and job scheduling, or other classical problems solved by quantum hardware. In some instances, the optimization problem may be a binary optimization problem where each variable can have two values. In certain instances, each variable in the optimization problem may have more than two values.

As shown in FIG. 2, the example optimization problem 202 is represented by a graph with nodes encoding N=12 variables and edges encoding interactions between nodes. The example quantum processing unit 204 includes qubit devices 222, 224, coupler devices 226, and other quantum circuit devices. As shown in FIG. 2, a qubit device 222, 224 is coupled to at least one neighboring qubit device 222, 224 through a respective coupler device 226. In some cases, one or both of the qubit devices 222, 224 represents an error-corrected logical qubit. The encoding scheme 200 operates with a many-to-one mapping of classical variables to qubits. In some examples, the example encoding scheme 200 may be applied to an optimization problem with any numbers of variables (N); and a quantum processing unit 204 may include any number of qubit devices in any geometric configuration or spatial arrangement. In certain instances, the quantum processing unit 204 may include additional or different components, and the components may be arranged as shown or in another manner.

As shown in FIG. 2, the N=12 nodes of the graph are divided into 4 groups 212A, 212B, 212C, 212D. Each group includes N/4=3 nodes. In particular, a first group 212A includes nodes 214A-1, 214A-2, 214A-3; a second group 212B includes nodes 214B-1, 214B-2, 214B-3; a third group 212C includes nodes 214C-1, 214C-2, 214C-3; and a fourth group 212D includes nodes 214D-1, 214D-2, 214D-3. In some implementations, the N=12 nodes may be divided into groups in another manner.

The quantum processing unit 204 includes five qubit devices. In some implementations, the five qubit devices are divided into two subsets, e.g., a data register including data qubit devices and a label register including label qubit devices. The data register includes d=3 data qubit devices 222-1, 222-2, 222-3 defining data qubits, which are configured to store values of the classical variables; and the label register includes log₂(N/d)=2 label qubit devices 224A, 224B defining log₂(N/d)=2 label qubits, which are configured to indicate which group of d variables should be assigned the d values stored in the data register. As shown in FIG. 2, the example encoding scheme 200 shown in FIG. 2 includes q=d+log₂(N/d)=5 qubits to encode N=12 variables.

In some implementations, each experimental shot of the hardware-efficient encoding scheme 200 shown in FIG. 2 may yield less information-only the values of one group of d variables-compared to the conventional binary encoding which yields all N values. For example, when an optimization problem includes N=1024 variables, the N=1024 variables of the optimization problem can be encoded on d=64 data qubits and log₂(N/d)=4 label qubits based on the example encoding scheme 200. The total number of qubits needed for encoding the N=1024 variables is q=d+log₂(N/d)=68. In some implementations, the hardware-efficient encodings using q=68 qubits can enable quantum algorithms to solve optimization problems at the scale of N=1024>>68 variables. When the optimization problem includes N=4 variables, the encoding scheme may be implemented as the example shown in FIGS. 5A, 5C.

In some instances, the quantum processing unit 204 includes a superconducting quantum processing circuit. The qubit devices 222, 224 may be implemented as tunable-frequency qubit devices, e.g., tunable-frequency transmon qubit devices, tunable-frequency flux qubit devices, tunable-frequency flatsonium qubit devices, tunable-frequency fluxonium qubit devices, or other types of tunable-frequency qubit devices. In some instances, a qubit device may be implemented as a fixed-frequency qubit device. In some implementations, each of the coupler devices 226 is a tunable-frequency coupler device which can be controlled to allow electromagnetic coupling or decoupling between the neighboring qubit devices 222, 224. For example, tunable-coupler devices 226 may be deactivated to segment qubit devices into QPU subsets. In some implementations, a topology of QPU subsets in a quantum processing unit 204 can be tuned, updated or otherwise changed by activating or disactivating the tunable-frequency coupler devices 226. In some instances, the coupler devices 226 may include one or more coupler elements providing a fixed coupling between two neighboring qubit devices 222, 224.

In the example quantum processing unit 204 shown in FIG. 2, each of the qubit devices 222, 224 can define a single bit of quantum information. Each of the qubit devices 222, 224 has two eigenstates that are used as computational basis states, and each qubit device can transition between its computational basis states or exist in an arbitrary superposition of its computational basis states. In some examples, the two lowest energy levels (e.g., the ground state |0 [symbol] and the first excited state |1) of each qubit device are defined as a qubit and used as computational basis states for quantum computation. In some examples, higher energy levels (e.g., a second excited state |2 [symbol] or a third excited state |3 [symbol] ) are also defined by a qubit device and may be used for quantum computation in some instances.

Qubits defined by respective qubit devices can be manipulated by control signals, or read by readout signals, generated by a control system (e.g., the control system 105). The qubit devices 222, 224 can be controlled individually, for example, by delivering control signals to the respective qubit devices. In some cases, the quantum processing unit 204 includes readout devices that can detect the qubits of the qubit devices 222, 224, for example, by interacting directly with the respective qubit devices 222, 224.

In some examples, a qubit device 222, 224, when implemented as a tunable-frequency qubit device which has a transition frequency that can be tuned, includes a quantum circuit loop (e.g., a SQUID loop). The quantum circuit loop receives a magnetic flux that tunes the transition frequency of the tunable-frequency qubit device. In some instances, the transition frequency can be tuned within a range of qubit operating frequencies. The quantum circuit loop may include two Josephson junctions, and the tunable-frequency qubit device may also include a shunt capacitor connected in parallel with each of the two Josephson junctions. In some examples, a transition frequency, which defines a qubit operating frequency of a tunable-frequency qubit device, is tunable, for example, by application of a magnetic flux. A qubit operating frequency of the tunable-frequency qubit device may be defined at least in part by Josephson energies of the two Josephson junctions, a capacitance of the shunt capacitor, and a magnetic flux threading the quantum circuit loop.

In some implementations, a coupler device 226, when implemented as a tunable-frequency coupler device, may receive control signals to enable electromagnetic coupling or decoupling between the qubit devices 222, 224. When two or more qubit devices are coupled, the two or more qubit devices can be used to perform multi-qubit quantum logic gates (e.g., perform quantum logic gates or operations proscribed by a quantum circuit).

In some implementations, the quantum processing unit 204 is a modular quantum processing unit. In some implementations, a modular quantum processing unit includes a two-dimensional or three-dimensional array of quantum processor modules that are interconnected to each other. Each of the quantum processor modules in a modular quantum processing unit may include a superconducting quantum integrated circuit (QuIC). The superconducting QuIC can include quantum circuit devices, for example, qubit devices (e.g., transmon devices, fluxonium devices, or other types of superconducting qubit devices), coupler devices (e.g., capacitive coupler device, tunable-frequency coupler device, or others), readout devices, or other types of quantum circuit devices that are used for quantum information processing in the modular quantum processing unit. The superconducting QuIC of each of the quantum processor modules may include one or more Josephson junctions, capacitors, inductors, and other types of circuit elements. Each of the quantum processor modules may include a two-dimensional or three-dimensional array of quantum circuit devices. In some instances, the modular quantum processing unit and each of the quantum processor modules may be implemented in another manner.

In some cases, neighboring quantum processor modules in a modular quantum processing unit are interconnected by superconducting circuitry which includes inter-chip coupler devices. For example, as shown in FIG. 2, two neighboring qubit devices 222, 224 may reside on two separate quantum processor modules and the coupler devices 226 can be implemented as inter-chip coupler devices that enable coupling of qubit devices in distinct quantum processor modules. In some implementations, inter-chip coupler devices are tunable. In some instances, coupling between two neighboring quantum processor modules may be activated or deactivated by communicating control signals to the inter-chip coupler devices.

In some implementations, the quantum computing system includes multiple quantum processing units 204 that are separately enclosed in distinct thermal environments (e.g., dilution refrigerator systems). For instance, each QPU may be housed in a separate dilution refrigerator that includes multiple thermal stages that create a very low temperature environment (e.g., T<120 K) for the QPU. As shown in FIG. 2, two or more of the qubit devices 222, 224 may reside on two quantum processing unit 204 in two separate dilution refrigerator systems. In this case, coupler devices 826 represent systems and interconnections between two quantum processing units 204 in two separate dilution refrigerator systems. For example, the coupler device 226 includes an optical link which can carry signals in the optical regime to control qubit devices, drive qubit devices, and generate entanglement between qubit devices in separated dilution refrigerator systems. In this case, the coupler device 226 includes optical components (e.g., optical fibers) and signal conversion/delivery units. In some instances, the coupler device 226 includes a superconducting link which can carry signals in the RF or microwave regime to control qubit devices, drive qubit devices, and generate entanglement between qubit devices in separated dilution refrigerator systems. In this case, the coupler device 226 includes superconducting circuit components (e.g., superconducting cabling) and signal delivery units. In some implementations, the coupler devices 226 can be controlled to activate or deactivate coupling between qubit devices in separate dilution refrigerator systems.

In some instances, the qubit devices 222, 224 may not have the desired topology as shown in FIG. 2. For example, qubit devices 222, 224 may not be physically positioned next to one another; and qubit devices may not be directly coupled through a single coupler device 226. Two qubit devices 222, 224 can be effectively coupled by performing quantum operations, e.g., by applying SWAP gates. In this case, the coupler device 226 between two qubit devices 222, 224 may include all the intermediate qubit devices and coupler devices, and all the required quantum operations and control operations applied on the respective qubit devices and coupler devices to effectively form the coupler device 226 between the two qubit devices 222, 224.

In some instances, the qubit devices 222, 224 and the coupling devices 226 are configured and may include devices and components according to the quantum processor modalities, e.g., photonic, trapped ion-based, topological, quantum dot-based, nuclear magnetic resonance, adiabatic, or other types, where the quantum program is executed.

FIG. 3 is a block diagram showing aspects of an example quantum logic circuit 300. In some implementations, the example quantum logic circuit 300 represents part of the quantum approximation optimization algorithm or a quantum alternative operator Ansatz (QAOA), a truncated single-layer QAOA, or another type of quantum program. The example quantum logic circuit 300 includes unitary operations applied to qubits defined by qubit devices of a quantum processing unit. In some implementations, the quantum logic circuit 300 represents part of a native quantum program with native quantum logic gates. In some instances, the example quantum logic circuit 300 includes unitary operations which may be generated by operation of a compiler in a server (e.g., the server 108 of the computing system 101 of FIG. 1) based on a quantum program (e.g., a user program) or may be received from a user device (e.g., the user device 110 of FIG. 1). In some implementations, the example quantum logic circuit 300 may be performed on a superconducting quantum processing unit (e.g., the example superconducting quantum processing unit 103A, 204, 504, 534, 604, 804 in FIGS. 1, 2, 5A, 5C, 6, 8A) or other quantum processor modalities.

As shown in FIG. 3, the example quantum logic circuit 300 includes a first layer of Hadamard gates applied to qubits 312 defined by qubit devices at a first time step t₁. A Hadamard gate 302 is configured to generate a target coherent superposition state on each of the qubit devices so as to produce an initial quantum state. All the qubits may be initially in |00 . . . 00 [symbol] . The example quantum logic circuit 300 includes an alternating sequence of a layer of two-qubit entangling gates and a layer of single-qubit quantum logic gates. A layer of two-qubit entangling gates 304 at a second time step t₂ each generate entanglement across pairs of qubit devices 222, 224 that are coupled by respective coupler devices 226. A layer of single-qubit quantum logic gates 306 at a third time step t₃ may include, for example, single qubit rotation operations. In some instances, the layer of single-qubit quantum logic gates 306 includes parametric single-qubit rotation gates with parameters defined by respective rotation angles. The initial values of the parameters may be randomly chosen. The example quantum logic circuit 300 further includes a layer of measurement operations to measure the output quantum states in the computational basis. The output of the measurement operation can be fed to a classical optimizer and used to evaluate a cost function, which is used to determine updated parameters for the single-qubit parametric gates 306. The quantum evolution can be repeated multiple times, and the parameters can be updated multiple times until convergence or if a set of termination criteria is met. In some instances, the operations 302 and 304 may be implemented as the operations 522 and 524 shown in FIG. 5B, which includes an example quantum logic circuit 520 for performing the encoding scheme shown in FIG. 5A; or implemented as the operations 552 and 554 shown in FIG. 5D, which includes an example quantum logic circuit 550 for performing the encoding scheme shown in FIG. 5C.

In some instances, a quantum logic gate, when applied to distinct quantum circuit devices, may be operated simultaneously during the same time step. Using the quantum processing unit 204 in FIG. 2 as an example, a two-qubit quantum logic gate in the layer of entangling gates 304 can be applied to data qubit devices 222-2 and 222-1 by activating a respective coupler device 226, deactivating coupler devices 226 to isolate the data qubit devices 222-3 and the label qubit devices 224A, 224B. In some instances, the quantum logic gates in the example quantum logic circuit 300 can be further decomposed into the hardware native gate set prior to being communicated to the quantum processing unit for execution. For instance, the single-qubit quantum logic gate Rx(φ) in the layer of single-qubit parametric gates 306 may be implemented for arbitrary angles using a standard “ZXZXZ” decomposition.

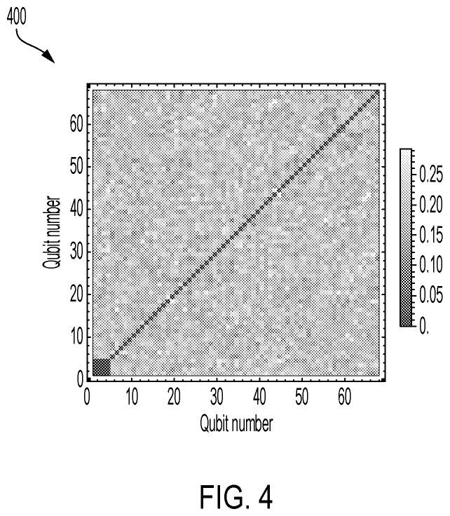

FIG. 4 is a plot showing the average correlation matrix as a function of qubit number based on the encoding scheme 200 shown in FIG. 2. Qubits numbered 5 through 68 represent data qubits; and qubits numbered 1 through 4 represent label qubits. The encoding scheme 200 can utilize entanglement among all qubits, in some instances.

FIG. 5A is a schematic diagram 500 showing aspects of an example encoding scheme 500. The encoding scheme 500 is configured to map variables of an example optimization problem 302 onto qubits defined by qubit devices 312, 314 in a quantum processing unit 304. As shown in FIG. 5A, the example optimization problem 502 is represented by a graph with nodes encoding N=4 variables and edges encoding interactions between nodes. In some instances, the optimization problem 502 is a weighted Maxcut problem. As shown in FIG. 5A, the qubit device in the quantum processing unit 504 includes data qubit devices 512-1, 512-2 and a label qubit device 514. As shown in FIG. 5A, the data qubit device 512-1, 512-2 can be communicably coupled to the label qubit device 514 through respective coupler devices 516. In some implementations, the data and label qubit devices 512-1, 512-2, 514 and the coupler device 516 may be implemented as the respective qubit devices 222, 224 and the coupling device 226 in FIG. 2 or in another manner. In some instances, a quantum processing unit 504 may include any number of qubit devices in any geometric configuration or spatial arrangement. In certain implementations, the quantum processing unit 504 may include additional or different components, and the components may be arranged as shown or in another manner.

In some instances, the encoding scheme 500 to map the N=4 classical variables of the optimization problem 502 onto the data qubit devices 512-1, 512-2 and the label qubit device 514 of the quantum processing unit 504 can be achieved by executing the quantum logic circuit 520 shown in FIG. 5B. In some instances, the encoding scheme 500 may be performed in another manner, e.g., by executing a different quantum logic circuit.

FIG. 5B is a block diagram showing aspects of an example quantum logic circuit 520. In some implementations, the example quantum logic circuit 520 corresponds to part of the quantum approximation optimization algorithm or a quantum alternative operator Ansatz (QAOA), a truncated single-layer QAOA, or another type of quantum program. The example quantum logic circuit 500 includes unitary operations applied to qubits defined data qubit devices and label qubit devices of a quantum processing unit (e.g., the data qubit device 512-1, 512-2 and the label qubit device 514 of the quantum processing unit 504 in FIG. 5A). In some implementations, the example quantum logic circuit 520 may be performed on a superconducting quantum processing unit (e.g., the example superconducting quantum processing unit 103A, 504 in FIGS. 1, 5A) or other quantum processor modalities. In some implementations, the example quantum logic circuit 520 is used to prepare a wavefunction by encoding a solution to the weighted Maxcut problem on N=4 nodes shown in FIG. 5A.

As shown in FIG. 5B, the example quantum logic circuit 520 includes a single-qubit Hadamard gate 522 applied to a label qubit 528 defined by the label qubit device 514 at a first time step t₁, which generates a target coherent superposition state on the label qubit device 514. The example quantum logic circuit 520 includes a first two-qubit CNOT gate 524A applied between the data qubit 526-1 and the label qubit 528 at a second time step t₂, and a second two-qubit CNOT gate 524B applied between the data qubit 526-2 and the label qubit 528 at a third time step t₃, each of which applies entangling operations to a respective pair of data qubit and label qubit 526-1/528 and 526-2/528.

In some instances, a quantum logic gate, when applied to distinct quantum circuit devices, may be operated simultaneously during the same time step. During the first time period t₁, the coupler devices 516 between each of the data qubit devices 512-1, 512-2 and the label qubit device 514 are deactivated isolating the label qubit device 514 from the data qubit devices 512-1, 512-2. During the second time period t₂, the coupler device 516 between the data qubit devices 512-2 and the label qubit device 514 are deactivated isolating the label qubit device 514 from the data qubit devices 512-2. During the third time period t₃, the coupler device 516 between the data qubit devices 512-1 and the label qubit device 514 are deactivated isolating the label qubit device 514 from the data qubit devices 512-1. In some instances, the quantum logic gates in the example quantum logic circuit 520 can be decomposed into the hardware native gate set, for example, by operation of a compiler of a control system (e.g., the control system 105 in FIG. 1).

In some instances, a wavefunction prepared using the example encoding scheme 500 shown in FIG. 5A by executing the example quantum logic circuit 520 can be expressed as:

$$\vert ψ 〉 = \frac{\vert 0 {〉}_{l a b e l} \vert 00 {〉}_{data} + \vert 1 {〉}_{l a b e l} \vert 11 {〉}_{data}}{normalization factor} \qquad ( 1 )$$

where the normalization factor is \sqrt{N/d}. When the N variables (z₁, z₂, . . . z_{N}) are divided into N/d groups of d variables, and encoded using q=d+log₂(N/d) qubits, the wavefunction in a general form can be expressed as:

$$\vert ψ 〉 = \frac{1}{\sqrt{\frac{N}{d}}} ( \vert 00 …00 {〉}_{label} \vert {z}_{1} {z}_{2} {…z}_{d} {〉}_{data} + \vert 00 …01 {〉}_{label} \vert {z}_{d + 1} {z}_{d + 2} {…z}_{2 d} {〉}_{data} + ⋯ \vert 11 …11 {〉}_{label} \vert {z}_{N - d + 1} {z}_{N - d + 2} {…z}_{N} {〉}_{datd} ) \qquad ( 2 )$$

FIG. 5C is a schematic diagram 530 showing aspects of an example encoding scheme 530. The encoding scheme 530 is configured to map variables of an example optimization problem 532 onto qubits defined by qubit devices 542, 544 in a quantum processing unit 534. As shown in FIG. 5C, the example optimization problem 532 is represented by a graph with nodes encoding N=4 variables and edges encoding interactions between nodes. In some instances, the optimization problem 532 is a weighted Maxcut problem. As shown in FIG. 5C, the qubit device 542, 544 in the quantum processing unit 534 includes a data qubit device 542 and two label qubit devices 544A, 544B. As shown in FIG. 5C, the data qubit device 542 can be communicably coupled to each of the label qubit devices 544A, 544B through respective coupler devices 546. In some implementations, the data and label qubit devices 542, 544A, 544B and the coupler device 546 may be implemented as the qubit devices 222, 224 and the coupling device 226 in FIG. 2 or in another manner. In some instances, a quantum processing unit 534 may include any number of qubit devices in any geometric configuration or spatial arrangement. In certain implementations, the quantum processing unit 534 may include additional or different components, and the components may be arranged as shown or in another manner.

In some instances, the encoding scheme 530 to map the N=4 classical variables of the optimization problem 532 onto the data qubit device 542 and the label qubit devices 544A, 544B can be achieved by executing the quantum logic circuit 550 shown in FIG. 5D or another quantum logic circuit. In some instances, the encoding scheme 530 may be performed in another manner, e.g., by executing a different quantum logic circuit.

FIG. 5D is a block diagram showing aspects of an example quantum logic circuit 550. In some implementations, the example quantum logic circuit 550 corresponds to part of the quantum approximation optimization algorithm or a quantum alternative operator Ansatz (QAOA), a truncated single-layer QAOA, or another type of quantum program. The example quantum logic circuit 550 includes unitary operations applied to qubits defined on data qubit devices and label qubit devices of a quantum processing unit (e.g., the data qubit device 542 and the label qubit devices 544A, 544B of the quantum processing unit 534 in FIG. 5C). In some implementations, the example quantum logic circuit 550 may be performed on a superconducting quantum processing unit (e.g., the example superconducting quantum processing unit 103A, 534 in FIGS. 1, 5C) or other quantum processor modalities. In some implementations, the example quantum logic circuit 550 is used to prepare a wave function by encoding variables to the weighted Maxcut problem on four nodes shown in FIG. 5C.

As shown in FIG. 5D, the example quantum logic circuit 550 includes a set of single-qubit Hadamard gates 552 applied to respective label qubits 558A, 558B defined by the label qubit device 544A, 544B at a first time step t₁, which generates a target coherent superposition state on the label qubit devices 544A, 544B. The example quantum logic circuit 550 includes a two-qubit CNOT gate 554 applied between the data qubit 556 and the label qubit 558A at a second time step t₂, which applies entangling operations to the data qubit 556 and label qubit 558A.

In some instances, a quantum logic gate, when applied to distinct quantum circuit devices, may be operated simultaneously during the same time step. During the first time period t₁, the coupler devices 546 between the data qubit device 542 and each of the label qubit devices 544A, 544B are deactivated isolating the label qubit devices 544A, 544B from the data qubit device 542. During the second time period t₂, the coupler device 546 between the data qubit devices 542 and the label qubit device 544B are deactivated isolating the data qubit device 542 from the label qubit device 544B. In some instances, the quantum logic gates in the example quantum logic circuit 550 can be decomposed into the hardware native gate set, for example, by operation of a compiler of a control system (e.g., the control system 105 in FIG. 1).

In some instances, a wavefunction prepared using the example encoding scheme 530 shown in FIG. 5C by executing the example quantum logic circuit 550 can be expressed as:

$$\vert ψ 〉 = \frac{\vert 00 {〉}_{l a b e l} \vert 0 {〉}_{data} + \vert 01 {〉}_{l a b e l} \vert 0 {〉}_{data}}{normalization factor} \qquad ( 3 )$$

where the normalization factor is N/d. When the N variables (z₁, z₂, . . . z_{N}) are divided into N/d groups of d variables, and encode them using q=d+log₂(N/d) qubits, the wavefunction in a general form can be expressed as the one in Equation 2 above.

FIG. 6 is a schematic diagram showing aspects of an example encoding scheme 600. The example encoding scheme 600 is configured to map classical variables of an optimization problem 602 onto qubits defined by qubit devices in a quantum processing unit 604. The example optimization problem may be a binary optimization problem in which each variable has two values or another type of optimization problem. The example optimization problem 602 is represented by a graph with nodes encoding N variables and edges encoding interactions between nodes. As shown in FIG. 6, the example quantum processing unit 604 includes qubit devices 622, 624, coupler devices 626, and other quantum circuit devices. As shown in FIG. 6, a qubit device 622, 624 is coupled to at least one neighboring qubit device 622, 624 through a respective coupler device 626. In some implementations, the encoding scheme 600 operates with a many-to-one mapping of classical variables to qubits. In some instances, the data and label qubit devices 622, 624 and the coupler device 626 may be implemented as the respective qubit devices 222, 224 and the coupling device 226 in FIG. 2 or in another manner. In some instances, a quantum processing unit 604 may include any number of qubit devices in any geometric configuration or spatial arrangement. In certain implementations, the optimization problem may include any number of variables (N); and the quantum processing unit 604 may include additional or different components, and the components may be arranged as shown or in another manner.

In some implementations, the N variables are divided into n clusters; and each

$$\frac{N}{n} / d$$

cluster includes N/n variables. The N/n variables in each cluster may be divided into groups with d variables each. Similarly, the qubit devices are divided into n corresponding subsets 612A, 612B, 612C, 612D. Each subset includes a data register including data qubit devices and a label register including label qubit devices. The data register in a subset 612 includes d data qubit devices 622-1, 622-2, 622-3 defining data qubits, which are configured to store values of the classical variables in a corresponding cluster; and the label register in a subset 612 includes

$${log}_{2} ( \frac{N}{n} / d )$$

label qubit devices 624A, 624B defining

$${log}_{2} ( \frac{N}{n} / d )$$

label qubits, which are configured to indicate which group of d variables should be assigned the d values stored in the data register. As shown in FIG. 6, the mapping shown in FIG. 6 includes

$$q = d + {log}_{2} ( \frac{N}{n} / d )$$

qubits to encode N/n variables in a cluster. A total number of

$$nq = n [ d + {log}_{2} ( \frac{N}{n} / d ) ]$$

qubits to encode N variables of the optimization problem 602. As shown in FIG. 6, each subset 612 includes 3 data qubits and 2 label qubits. In some instances, each subset 612 may include more than 3 data qubits and more than 2 label qubits. As shown in FIG. 6, the data qubits in the same subset 612 are coupled to one another; each of the data qubits is also entangled with the label qubits in the same subset 612. In this example, qubits in one subset 612 are not entangled with other qubits in different subsets.

For example, when the optimization problem 602 includes N=1024 variables and the N=1024 variables are divided into n=4 cluster, each of which includes

$$\frac{N}{n} = 256$$

variables. The 256 variables in a cluster are separated into

$$\frac{N}{n} / d = 16$$

groups with d=16 variables in each group. As shown in FIG. 6, the encoding scheme 600 shown in FIG. 6 can map the N/n=256 variables in a cluster on to

$$q = d + {log}_{2} ( \frac{N}{n} / d ) = 20$$

qubits in a corresponding subset 612. In total, the encoding scheme shown in FIG. 6 utilizes nq=80 qubits to encode the N=1024 variables. In some implementations, the encoding scheme 800 using nq=80 qubits will enable quantum algorithms to solve optimization problems at the scale of N=1024>>80 variables. When the optimization problem 602 includes N=8 variables, the encoding scheme 600 may be implemented as the encoding scheme 800 shown in FIG. 8A.

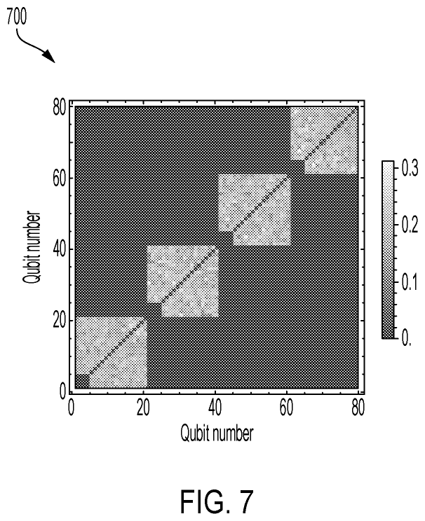

FIG. 7 is a plot showing the average correlation matrix as a function of qubit number based on the encoding scheme 600 shown in FIG. 6. Qubits numbered 5-20, 25-40, 45-60, and 65-80 represent data qubits; and qubits numbered 1-4, 21-24, 41-44, and 61-64 represent label qubits. As shown in FIG. 7, no entanglement is needed among qubits from different subsets. In some instances, the encoding scheme 600 can effectively further reduce hardware and operational overhead associated with generating entanglement among qubit devices.

FIG. 8A is a schematic diagram showing aspects of an example encoding scheme 800. The encoding scheme 800 is configured to map classical variables of an example optimization problem 802 onto qubits of qubit devices 812, 814 in a quantum processing unit 804. The example optimization problem 802 is represented by a graph with nodes encoding N=8 variables and edges encoding interactions between nodes. In some instances, the optimization problem 802 is a weighted Maxcut problem. The N=8 variables are divided into n=2 clusters 808A, 808B each including N/n=4 variables. As shown in FIG. 8A, the qubit devices in the quantum processing unit 804 are divided into two subsets 806A, 806B corresponding to the two clusters 808A, 808B. Each subset includes three qubit devices. In particular, the subset 806A includes data qubit devices 812A-1, 812A-2, and a label qubit device 814A on which the variables from the cluster 808A may be mapped; and the subset 806B includes data qubit devices 812B-1, 812B-2, and a label qubit device 814B on which the variables from the cluster 808B may be mapped. In some implementations, a cluster of variables are associated with a subset of qubits; and respective groups of variables in the same cluster are associated with data qubits within the associated subset when the label qubit is at respective basis states.

As shown in FIG. 8A, the data qubit device 812A-1, 812A-2 can be communicably coupled to the label qubit device 814A through respective coupler devices 816 in the subset 806A; and the data qubit device 812B-1, 812B-2 can be communicably coupled to the label qubit device 814B through respective coupler devices 816 in the subset 806B. In the example shown, data qubits from different subsets 806A, 806B are not communicably coupled to one another; and data qubits and label qubits from different subsets 806A, 806B are not communicably coupled to one another. In some instances, coupler devices between qubit devices can be deactivated to effectively form the different subsets. In some implementations, the data qubit devices 812A-1, 812A-2, 812B-1, 812B-2 and the label qubit devices 814A, 814B may be implemented as the qubit devices 222, 224 and the coupling device 226 in FIG. 2 or in another manner. In some instances, a quantum processing unit 804 may include any number of qubit devices in any geometric configuration or spatial arrangement. In certain implementations, the quantum processing unit 804 may include additional or different components, and the components may be arranged as shown or in another manner.

In some instances, the encoding scheme 800 to map the N=8 classical variables of the optimization problem 802 onto the two subsets 806A, 806B of the quantum processing unit 804 can be achieved by executing the quantum logic circuit 820 shown in FIG. 8B. In some instances, the encoding scheme 800 may be performed in another manner, e.g., by executing a different quantum logic circuit.

FIG. 8B is a block diagram showing aspects of an example quantum logic circuit 820. In some implementations, the example quantum logic circuit 820 corresponds to part of the quantum approximation optimization algorithm or a quantum alternative operator Ansatz (QAOA), a truncated single-layer QAOA, or another type of quantum program. The example quantum logic circuit 820 includes unitary operations applied to qubits defined data qubit devices and label qubit devices of a quantum processing unit (e.g., the data qubit device 812A-1, 812A-2, 812B-1, 812B-2, and the label qubit devices 814A, 814B of the quantum processing unit 804 in FIG. 8A). In some implementations, the example quantum logic circuit 820 may be performed on a superconducting quantum processing unit (e.g., the example superconducting quantum processing unit 103A, 804 in FIGS. 1, 8A) or other quantum processor modalities. In some implementations, the example quantum logic circuit 820 is used to prepare a wavefunction by encoding a solution to the weighted Maxcut problem on N=8 nodes shown in FIG. 8A.

As shown in FIG. 8B, the example quantum logic circuit 820 includes a set of single-qubit Hadamard gates 822 applied to label qubits 828A, 828B defined by the respective label qubit device 814A, 814B of the respective clusters 806A, 806B at a first time step t₁, which generates a target coherent superposition state on the label qubit devices 814A, 814B. The example quantum logic circuit 520 includes a first set of two-qubit CNOT gates 824A applied between the data qubit 826A-1 and the label qubit 828A defined by the respective data qubit device 812A-1 and the label qubit device 814A in the cluster 806A and applied between the data qubit 826B-1 and the label qubit 828B defined by the respective data qubit device 812B-1 and the label qubit device 814B in the cluster 806B at a second time step t₂; and a second set of two-qubit CNOT gates 824B applied between the data qubit 826A-2 and the label qubit 828A defined by the respective data qubit device 812A-2 and the label qubit device 814A in the cluster 806A and applied between the data qubit 826B-2 and the label qubit 828B defined by the respective data qubit device 812B-2 and the label qubit device 814B in the cluster 806B at a third time step t₃, each of which is configured to apply entangling operations to a respective pair of data qubit and label qubit defined by respective qubit devices in the same cluster.

In some instances, a quantum logic gate, when applied to distinct quantum circuit devices, may be operated simultaneously during the same time step. During the first time period t₁, the coupler device 816 between each of the data qubit devices 812A-1, 812A-2 and the label qubit device 814A in the cluster 806A and the coupler device 816 between each of the data qubit devices 812B-1, 812B-2 and the label qubit device 814B in the cluster 806B are deactivated isolating the label qubit devices 814A, 814B from the respective data qubit devices in the same cluster. During the second time period t₂, the coupler device 816 between the data qubit devices 812A-2 and the label qubit device 814A in the cluster 806A and the coupler device 816 between the data qubit devices 812B-2 and the label qubit device 814B in the cluster 806B are deactivated isolating the label qubit device 814A, 814B from the respective data qubit devices 812A-2, 812B-2 in the respective clusters. During the third time period t₃, the coupler device 816 between the data qubit devices 812A-1 and the label qubit device 814A in the cluster 806A and the coupler device 816 between the data qubit devices 812B-1 and the label qubit device 814B in the cluster 806B are deactivated isolating the label qubit device 814A, 814B from the data qubit devices 812A-1, 812B-1 in the respective clusters. In some instances, the quantum logic gates in the example quantum logic circuit 820 can be decomposed into the hardware native gate set, for example, by operation of a compiler of a control system (e.g., the control system 105 in FIG. 1).

In some instances, a wavefunction prepared using the example encoding scheme 800 shown in FIG. 8A by executing the example quantum logic circuit 820 can be expressed as

$$\vert ψ 〉 = \frac{1}{normalization factor} ( \vert 0 {〉}_{label 1} \vert 00 {〉}_{data 1} + \vert 1 {〉}_{label 1} \vert 11 {〉}_{data 1} ) ⊗ \text{(\textbar} \text{} 0 {〉}_{label 2} \vert 00 {〉}_{data2} + \vert 1 {〉}_{label 2} \vert 11 {〉}_{data 2} ) \qquad ( 4 )$$

where the normalization factor is (N/n/d)^{n/2}. When the N variables (z₁, z₂, . . . z_{N}) are divided into n clusters, and each cluster is divided into N/n/d groups of d variables, and the N variables are encoded using

$$nq = n [ d + {log}_{2} ( \frac{N}{n} / d ) ] qubits ,$$

the wavefunction in a general form can be expressed as:

$$\vert ψ 〉 = \frac{1}{\sqrt{\frac{N / n}{d}}} ( \vert 00 …00 {〉}_{label 1} \vert {z}_{1} {z}_{2} {…z}_{d} {〉}_{data 1} + ⋯ + \qquad ( 5 )$$

$$\vert 11 …11 {〉}_{label 1} \vert {z}_{\frac{N}{n} - d + 1} {z}_{\frac{N}{n} - d + 2} {…z}_{\frac{N}{n}} {〉}_{data 1} ) *$$

$$\frac{1}{\sqrt{\frac{N / n}{d}}} ( \vert 00 …00 {〉}_{label 2} \vert {z}_{\frac{N}{n} + 1} {z}_{\frac{N}{n} + 2} {…z}_{\frac{N}{n} + d} {〉}_{data 2} + ⋯ +$$

$$\vert 11 …11 {〉}_{label 2} \vert {z}_{\frac{2 N}{n} - d + 1} {z}_{\frac{2 N}{n} - d + 2} {…z}_{\frac{2 N}{n}} {〉}_{data 2} ) *$$

$$⋯ \frac{1}{\sqrt{\frac{N / n}{d}}} ( \vert 00 …00 {〉}_{labeln} \vert {z}_{N - n + 1} {z}_{N - n + 2} {…z}_{N - n + d} {〉}_{datan} + ⋯ +$$

$$\vert 11 …11 {〉}_{label n} \vert {z}_{N - d + 1} {z}_{N - d + 2} {…z}_{N} {〉}_{datan}$$

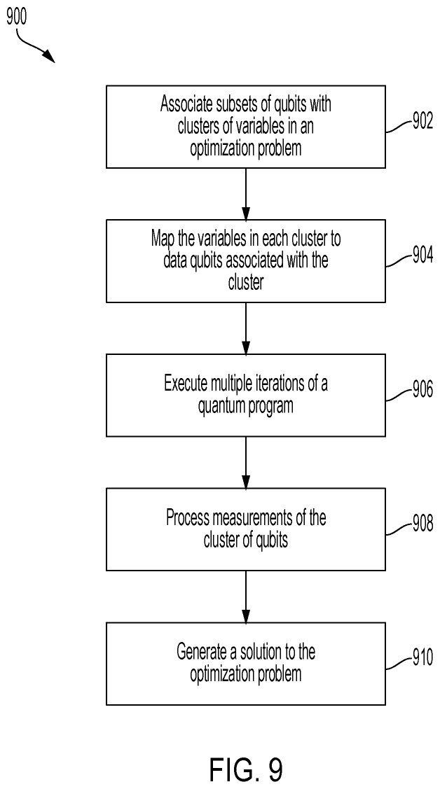

FIG. 9 is a flow chart showing aspects of an example process 900. In some implementations, the example process 900 is used to perform an encoding scheme for solving an optimization problem. The example process 900 may include additional or different operations, and the operations may be performed in the order shown or in another order. In some cases, operations in the example process 900 can be combined, iterated or otherwise repeated, or performed in another manner.

At 902, subsets of qubits are associated with clusters of variables in an optimization problem. In some implementations, the N variables are divided into n clusters, each cluster including N/n variables; and each cluster of variables are divided into N/nd of groups. A set of qubits in a quantum processing unit can be identified for solving the optimization problem. The set of qubits are divided into n subsets, each subset including d data qubits and

$${log}_{2} ( \frac{N}{n} / d )$$

label qubits. The

$$[ d + {log}_{2} ( \frac{N}{n} / d ) ]$$

qubits in a subset are associated with a cluster of variables; and the

$$[ nd + n {log}_{2} ( \frac{N}{n} / d ) ]$$

qubits are associated with the N variables. Once the subsets of qubits are associated with the clusters of variables, an encoding scheme is determined. The encoding scheme is configured to perform a many-to-one mapping of classical variables of an optimization problem to qubits defined by qubit devices in a quantum processing unit. In some instances, the encoding scheme is determined according to the number of variables in the optimization problem and available quantum resources (e.g., number of qubit devices and coupling among qubit devices), or other factors. In some instances, the encoding scheme may be defined in the same or a similar manner as the examples shown in FIGS. 2, 5A, 5C, 6, 8A, or the encoding scheme may be determined in another manner.

At 904, the variables in each cluster are mapped to the data qubits associated with the cluster. In some implementations, the encoding scheme is performed to map the variables in each cluster to the data qubits associated with the cluster. The encoding scheme may be performed in the same or a similar manner as the operations in the examples shown in FIGS. 2, 5A, 5C, 6, 8A, or the encoding scheme may be performed in another manner. In some instances, the encoding scheme may be performed by executing the quantum logic circuit 300, 520, 550, 820 shown in FIGS. 3, 5B, 5D, 8B or in another manner.

Using the encoding scheme 800 shown in FIG. 8A as an example, the 8 variables (e.g., V1, V2, . . . , V8) in the optimization problem can be divided into 2 clusters, e.g., a first cluster 808A and a second cluster 808B. The first cluster 808A includes variables V1, V2, V3, and V4; and the second cluster 808B includes variables V5, V6, V7, and V8. 2 clusters of variables can be associated with 2 subsets of qubits. The first cluster 808A is divided into 2 groups, e.g., a first group including variables V1 and V2; and a second group including variables V3 and V4. The second cluster 808B is also divided into 2 groups, e.g., a third group including variables V5 and V6; and a fourth group including variables V7 and V8. When the variables V1, V2, V3, and V4 from the first cluster 808A are mapped onto data qubits 812A-1, 812A-2 in the first subset 806A, basis states (e.g., |0 [symbol] and |1 [symbol] ) of the label qubit 814A associated with the first subset 806A are identified. For example, variables V1 and V2 of the first group can be mapped to the data qubits 812A-1, 812A-2, respectively, when the basis state of the label qubit 814A is |0); and variables V3 and V4 of the second group can be mapped to the data qubits 812A-1, 812A-2, respectively, when the basis state of the label qubit 814A is | 1). In this case, the variables V1 and V3 are mapped onto the same data qubit 812A-1; and the variables V2 and V4 are mapped onto the same data qubit 812A-2. In other words, when the basis state of the label qubit 814A is |0), the data qubits 812A-1, 812A-2 are associated with variables V1 and V2 in the first group; and when the basis state of the label qubit 814A is |1), the data qubits 812A-1, 812A-2 are associated with variables V3 and V4 in the second group. Similarly, variables V5 and V6 of the third group can be mapped to the data qubits 812B-1, 812B-2, respectively, when the basis state of the label qubit 814B is |0 [symbol] ; and variables V7 and V8 of the fourth group can be mapped to the data qubits 812B-1, 812B-2, respectively, when the basis state of the label qubit 814B is |1 [symbol] . In this case, the variables V5 and V7 are mapped onto the same data qubit 812B-1; and the variables V6 and V8 are mapped onto the same data qubit 812B-2. In other words, when the basis state of the label qubit 814B is |0 [symbol] , the data qubits 812B-1, 812B-2 are associated with variables V5 and V6 in the third group; and when the basis state of the label qubit 814B is |1), the data qubits 812B-1, 812B-2 are associated with variables V7 and V8 in the fourth group. In some instances, the 2 clusters of variables may include randomly selected 4 variables and each group may also include randomly selected 2 variables. In some instances, the variables within a group may be mapped onto data qubits when the label qubit is at a different basis state. For example, variables V1 and V2 of the first group can be mapped to the data qubits 812A-1, 812A-2, respectively, when the basis state of the label qubit 814A is |1 [symbol] ; and variables V3 and V4 of the second group can be mapped to the data qubits 812A-1, 812A-2, respectively, when the basis state of the label qubit 814A is |0 [symbol] . In some instances, mapping of the variables to data qubits may be performed in another manner.

At 906, a quantum logic circuit is executed by operation of the quantum processing unit. In certain instances, at least a portion of the quantum logic circuit may be determined based on the determined encoding scheme, e.g., a number of total qubits, number of data qubits, a number of label qubits, available hardware resources for activating and deactivating coupling between qubit devices, etc. For example, the layers of single-qubit quantum logic gates 522, 552, 822, and the layers of two-qubit entangling gates 524A, 524B, 554, 824A, 824B in the example quantum logic circuit 520, 550, 820 shown in FIGS. 5B, 5D and 8A are determined based on the corresponding encoding schemes 500, 530, 800 shown in FIGS. 5A, 5C, 8A. In some implementations, executing a circuit portion of the quantum logic circuit prepares each subset of qubits in an entangled state. In certain examples, executing the circuit portion of the quantum logic circuit can generate a target coherent superposition state so as to produce an initial quantum state. In some instances, the example initial quantum state is the equal superposition state. In some instances, at least a portion of the quantum logic circuit may be further determined by the optimization problem.

In some instances, a quantum logic circuit comprised of a series of quantum logic gates can be applied to the data qubits and the label qubits within the same subset. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing.

In some instances, the quantum logic circuit may include parameterized quantum logic circuits, where the parameters are selected such that the sampled output of the quantum logic circuit returns the best possible output when being executed by the QPU, with respect to the optimization problem. In some instances, the quantum logic circuit is executed by operation of a hybrid quantum-classical computing system, e.g., the quantum processing unit (e.g., the quantum processing unit 102 in FIG. 1) and the classical processing unit (e.g., the control system 104 in FIG. 1). In some instances, the quantum logic circuit may be implemented as the quantum logic circuit 300 shown in FIG. 3 applied to the data qubits and the label qubits or in another manner.

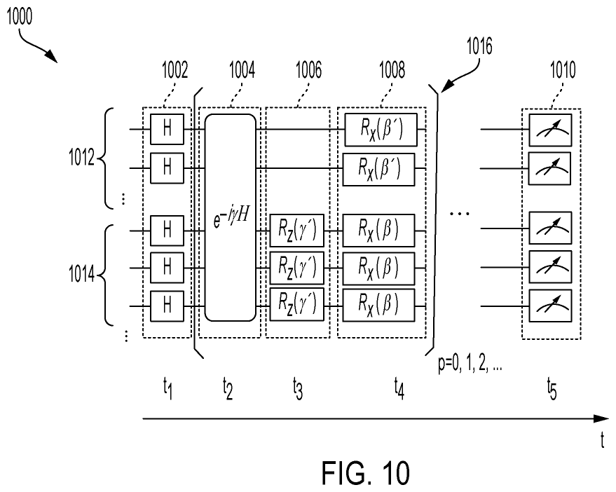

When the determined quantum logic circuit is executed on a subset of qubits, qubits in the subset are prepared in an entangled state, e.g., by executing a first portion (e.g., the Hadamard gates 1002 and the two-qubit entangling gates 1004 in the example quantum logic circuit 1000 shown in FIG. 10) of the quantum logic circuit. A second portion of the quantum logic circuit (e.g., the single-qubit quantum logic gates 1006, 1008 in the example quantum logic circuit 1000 shown in FIG. 10) corresponding to the optimization problem is applied on the subset of qubits after the entangled state is prepared.

In some implementations, the data qubits and label qubits in the subset are measured to obtain output quantum states, which include measured states of the data qubits and measured states of the label qubits. After the application of the quantum logic circuit, the data qubits and the label qubits are measured by operation of the quantum processing unit. During the measurement, the quantum states of the data qubits and label qubits are collapsed to one of their respective basis states (|0 [symbol] or |1 [symbol] ). After measurement, classical information is extracted from the quantum computation. For example, classical bits representing the measurement output quantum states of the data qubits and the label qubits can be obtained.

In certain examples, multiple iterations of executing the quantum logic circuit and performing measurement are performed. In some instances, during the multiple iterations of the quantum logic circuit, the quantum logic circuit may be modified, for example, increasing the number of layers (in the example shown in FIG. 10), updating gate parameters, etc. In some instances, modifying the quantum logic circuit during multiple iterations can be determined by the measured states of the data qubits and the label qubits.

At 908, the measurements are processed. In some implementations, when the measurements are processed, which variables are represented by the measured states of the data qubits according to the measured states of the label qubits can be determined for each measurement. In some instances, processing the measurements generates average values of the variables defined by the measured states of the data qubits and the label qubits.

At 910, a solution to the optimization problem is generated. In some implementations, a cost function is evaluated based on the measured output quantum states. The output quantum states of the measurement operation can be fed to a classical optimizer and used to evaluate a cost function, which is used to determine updated parameters of the quantum logic circuits. The quantum evolution (e.g., the operations 906, 908) can be repeated multiple times and the parameters can be updated multiple times until convergence or if a set of termination criteria is met.

In some instances, the qubit-efficient encoding scheme can be used to minimize a cost function. In some implementations, the cost function is expressed as:

$$C = {\sum }_{i = 1}^{N} {\sum }_{j < i} {w}_{ij} {z}_{i} {z}_{j} , \qquad ( 6 )$$

where zᵢ and zⱼ are binary variables which can take only values ±1, i and j are integers in a range of 1 to N, and wᵢⱼ=wⱼᵢ are arbitrary real numbers. If the N variables are grouped into N/d groups and each group includes d variables, the N variables can be encoded with q=d+log₂(N/d) qubits using the example encoding scheme 200 shown in FIG. 2. The cost function in equation (6) can be written in the terms of the wavefunction |4 [symbol] of the q qubits as:

$$C = {\sum }_{ij , {l}_{i} = {l}_{j}} {w}_{ij} \frac{〈 ψ \vert {P}_{{l}_{i}} {σ}_{{d}_{i}}^{z} {σ}_{{d}_{j}}^{z} \vert ψ 〉}{〈 ψ \vert {P}_{{l}_{i}} \vert ψ 〉} + {\sum }_{ij , {l}_{i} \neq {l}_{j}} {w}_{ij} \frac{〈 ψ \vert {P}_{{l}_{i}} {σ}_{{d}_{i}}^{z} \vert ψ 〉}{〈 ψ \vert {P}_{{l}_{i}} \vert ψ 〉} \frac{〈 ψ \vert {P}_{{l}_{j}} {σ}_{{jd}_{j}}^{z} \vert ψ 〉}{〈 ψ \vert {P}_{{l}_{j}} \vert ψ 〉} , \qquad ( 7 )$$

where lᵢ and lⱼ are the values of the label qubits for variables i and j, Pₗ_{ᵢ} and Pₗ_{ⱼ} are projection operators onto those values, dᵢ and dⱼ are the indices of the data qubits for variables i and j, and

$${σ}_{{d}_{i}}^{z} and {σ}_{{d}_{j}}^{z}$$

are the Pauli-z operators on those data qubits.

FIG. 10 is a block diagram showing aspects of an example quantum logic circuit 1000. In some implementations, the example quantum logic circuit 1000 represents part of a variational ansatz for solving optimization problems with N variables based on an encoding scheme. The encoding scheme utilizes log₂(N/d) label qubits and d data qubits for a total number of q=d+log₂(N/d) qubits to represent the N variables of the optimization problem. The encoding scheme may be implemented as the encoding scheme 200 in FIG. 2 or in another manner. The example quantum logic circuit 1000 includes unitary operations applied to qubits defined by qubit devices of a quantum processing unit. (e.g., the example superconducting quantum processing unit 103A, 204 in FIGS. 1, 2) or other quantum processor modalities.

As shown in FIG. 10, the example quantum logic circuit 1000 includes a set of Hadamard gates 1002 applied to label qubits 1012 defined by label qubit devices (e.g., the label qubit devices 224A, 224B in FIG. 2) and data qubits 1014 defined by data qubit devices (e.g., the data qubit device 222-1, 222-2, 222-3 in FIG. 2) at a first time step t₁. A Hadamard gate 1002 is configured to generate a target coherent superposition state on each of the qubit devices so as to prepare the qubits in the equal superposition state. All the qubits may be initially in |00 . . . 00 [symbol] .

As shown in FIG. 10, the example quantum logic circuit 1000 includes p layers of circuit portions 1016, where p=0, 1, 2, . . . . Each layer of the circuit portion 1016 includes a set of two-qubit entangling gates 1004 at a second time step t₂ each generate entanglement across pairs of qubit devices 1012, 1014, e.g., the qubit devices 222, 224 that are coupled by respective coupler devices 226. In some implementations, the input Hamiltonian to the entangling gates 1004 of the (p+1)-th layer of the circuit portion 1016 is given by

$${H}_{p + 1} = {\sum }_{ij , {l}_{i} = {l}_{j}} {w}_{ij} \frac{{P}_{{l}_{i}} {σ}_{{d}_{i}}^{z} {σ}_{{d}_{j}}^{z}}{〈 {ψ}_{p} \vert {P}_{{l}_{i}} \vert {ψ}_{p} 〉} + \frac{1}{2} {\sum }_{ij , {l}_{i} \neq {l}_{j}} {w}_{ij} \frac{{P}_{{l}_{i}} {σ}_{{d}_{i}}^{z}}{〈 {ψ}_{p} \vert {P}_{{l}_{i}} \vert {ψ}_{p} 〉} \frac{〈 {ψ}_{p} \vert {P}_{{l}_{j}} {σ}_{{d}_{j}}^{z} \vert {ψ}_{p} 〉}{〈 {ψ}_{p} \vert {P}_{{l}_{j}} \vert {ψ}_{p} 〉} + \frac{1}{2} {\sum }_{ij , {l}_{i} \neq {l}_{j}} {w}_{ij} \frac{{P}_{{l}_{j}} {σ}_{{d}_{j}}^{z}}{〈 {ψ}_{p} \vert {P}_{{l}_{j}} \vert {ψ}_{p} 〉} \frac{〈 {ψ}_{p} \vert {P}_{{l}_{i}} {σ}_{{d}_{i}}^{z} \vert {ψ}_{p} 〉}{〈 {ψ}_{p} \vert {P}_{{l}_{i}} \vert {ψ}_{p} 〉} , \qquad ( 8 )$$

where the probability [symbol] ψₚ|Pᵢ_{ⱼ}|ψₚ [symbol] of measuring label qubits as lᵢ and the expectation values

$$〈 {ψ}_{p} \vert {P}_{{l}_{i}} {σ}_{{d}_{i}}^{z} \vert {ψ}_{p} 〉$$

of data qubits while measuring the label qubits as lᵢ are computed from measurements by execution of a quantum logic circuit with p layers of the circuit portion 1016. For example, when p=1, the measurement used for determining the expectation values of the data qubits and the probability of measuring the label qubits as lᵢ and thus the input Hamiltonian (e.g., H₁) to the entangling gates in the single layer of the circuit portion 1016 is based on the output of the measurement operation 1010 during the execution of the quantum logic circuit 1000 at p=0; when p=2, the measurement used for determining the expectation values of the data qubits and the probability of measuring the label qubits as lᵢ and thus the input Hamiltonian (e.g., H₂) to the entangling gates in the second layer of the circuit portion 1016 is based on the output of the measurement operation during the execution of the quantum logic circuit 1000 at p=1; and the measurement used for determining the expectation values of the data qubits and the probability of measuring the label qubits as lᵢ in the p-th layer of the circuit portion 1016; and thus the input Hamiltonian (e.g., Hₚ₊₁) to the entangling gates in the (p+1)-th layer of the circuit portion 1016 is determined based on the output of the measurement operation in the p-th layer. In some instances, the entangling gates 1004 in each layer of the circuit portion 1016 can be decomposed into two-qubit quantum logic gates available on the hardware using standard gate-decomposition techniques, e.g., by operation of a compiler.

The circuit portion 1016 includes a set of single-qubit quantum logic gates 1006 applied to the data qubits 1014 at a third time step t₃. The single-qubit quantum logic gates 1006 includes parametric single qubit Z-rotation gates with parameters defined by respective rotation angles (γ′). The initial values of the parameters may be randomly chosen. The circuit portion 1016 further includes a set of single-qubit quantum logic gates 1008 applied to the label and data qubits 1012, 1014 at a fourth time step t₄. The single-qubit quantum logic gates 1008 includes parametric single qubit X-rotation gates with parameters defined by respective rotation angles (β and β′). The quantum logic circuit 1000 further includes a set of measurement operations 1010 at a fifth time step t₅ to measure the output quantum states in the computational basis.

To determine the value of the input Hamiltonian for the entangling gates, the probability of measuring the label qubits as lᵢ, the expectation value of the data qubits, and possibly other parameters can be used as shown in Equation (8). In some instances, the probability of measuring the label qubits as lᵢ can be measured on label qubits. Set x=0. To calculate the probability of measuring the label qubits as lᵢ, if the value of the label qubits is lᵢ, increment x by 1. The probability of measuring the label qubits as lᵢ, is x divided by the total number of repetitions in the quantum logic circuit 1000. In some instances, the expectation value of the data qubits can be measured. In each shot, measure all the qubits. Set x=0, y=0. For each shot, if the label qubits have the value lᵢ, then increment x by 1 and increment y by the value of the data qubit. Finally, the expectation value of the data qubits is y/x. In some implementations, the measurement of expectation value of data qubits is performed simultaneously with the measurement of the probability of measuring the label qubits as lᵢ. In some implementations, the probability [symbol] ψₚ|Pₗ_{ⱼ}|ψₚ [symbol] of measuring label qubits as lᵢ and the expectation values

$$〈 {ψ}_{p} \vert {P}_{{l}_{i}} {σ}_{{d}_{i}}^{z} \vert {ψ}_{p} 〉$$

of data qubits while measuring the label qubits as lᵢ are computed from measurements to determine the input Hamiltonian for the next layer.

For example, when p=0, after the set of Hadamard gates 1002 for preparing the superposition states, the example quantum logic circuit 1000 does not include any layer of the circuit portion 1016; and includes a set of measurement operations 1010 to measure the output quantum states in the computational basis. The measurement operations 1010 can determine the input Hamiltonian (e.g., H₁) to the first layer of the circuit portion 1016 of the example quantum logic circuit 1000.

When p=1, after the set of Hadamard gates 1002, the example quantum logic circuit 1000 includes a single layer of the circuit portion 1016, which includes a set of entangling gates 1004, a set of single-qubit rotation gates 1006 applied to the data qubits 1014, and a set of single-qubit rotation gates 1008 applied to the data and label qubits. The example quantum logic circuit 1000 includes a set of measurement operations 1010. The set of entangling gates 1004 in the circuit portion 1016 receives the input Hamiltonian (e.g., H₁) determined from measurement operations at p=0. Initial values of the gate parameters in the single layer of the circuit portion 1016

$$( e . g . , {γ}_{1} , {γ}_{1}^{′} , {β}_{1} , {β}_{1}^{′} )$$

can be selected randomly. The output quantum states of the measurement operation 1010 can be fed to a classical optimizer and used to evaluate a cost function, which is used to determine updated values of the gate parameters

$$( e . g . , {γ}_{1} , {γ}_{1}^{′} , {β}_{1} , {β}_{1}^{′} ) .$$

Subsequently, the quantum logic circuit 1000 at p=1 can be executed with the updated parameters of quantum logic circuit 1000, the measurement operation 1010 can determine values of parameters that can be used to determine the input Hamiltonian (e.g., H₂) to the second layer of the circuit portion 1016 of the example quantum logic circuit 1000.

When p=2, after the set of Hadamard gates 1002, the example quantum logic circuit 1000 includes two layers of the circuit portion 1016. The first layer includes a set of entangling gates 1004-1, a set of single-qubit rotation gates 1006-1 applied to the data qubits 1014, and a set of single-qubit rotation gates 1008-1 applied to the data and label qubits 1012, 1014. The set of entangling gates 1004-1 in the first layer of the circuit portion 1016 receives the input Hamiltonian (e.g., H₁) determined from the execution of the quantum logic circuit at p=0 as describe above. The second layer includes a set of entangling gates 1004-2, a set of single-qubit rotation gates 1006-2 applied to the data qubits 1014, and a set of single-qubit rotation gates 1008-2 applied to the data and label qubits 1012, 1014. The set of entangling gates 1004 in the second layer of the circuit portion 1016 receives the input Hamiltonian (e.g., H₂) determined from measurement operations at p=1. Initial values of the gate parameters

$$( e . g . , {γ}_{1} , {γ}_{1}^{′} , {β}_{1} , {β}_{1}^{′} , {γ}_{2} , {γ}_{2}^{′} , {β}_{2} , {β}_{2}^{′} )$$

be selected randomly. The output quantum states of the measurement operation 1010 can be fed to a classical optimizer and used to evaluate a cost function, which is used to determine updated values of the gate parameters

$$( e . g . , {γ}_{1} , {γ}_{1}^{′} , {β}_{1} , {β}_{1}^{′} , {γ}_{2} , {γ}_{2}^{′} , {β}_{2} , {β}_{2}^{′} ) .$$

The quantum logic circuit 1000 at p=2 can be executed with the determined values of the parameters

$$( e . g . , {H}_{1} , {γ}_{1} , {γ}_{1}^{′} , {β}_{1} , {β}_{1}^{′} , {H}_{2} , {γ}_{2} , {γ}_{2}^{′} , {β}_{2} , {β}_{2}^{′} ) .$$

The measurement operation 1010 can determine values of parameters that can be used to determine the input Hamiltonian (e.g., H₃) to the third layer of the circuit portion 1016 of the example quantum logic circuit 1000.

Generally, when the quantum logic circuit 1000 includes p layers of the circuit portion 1016, the sets of entangling gates 1004-1, 1004-2, . . . , 1004-p in the p layers of the circuit portion 1016 receive input Hamiltonian (e.g., H₁, H₂, . . . , Hₚ₋₁, Hₚ) determined from the execution of the quantum logic circuit 1000 at 0, 1, . . . , p−1. The p-th layer of the circuit portion 1016 includes a set of entangling gates 1004-p, a set of single-qubit rotation gates 1006-p applied to the data qubits 1014, and a set of single-qubit rotation gates 1008-p applied to the data and label qubits 1012, 1014. Initial values of the gate parameters

$$\\ ( e . g . , {γ}_{1} , {γ}_{1}^{′} , {β}_{1} , {β}_{1}^{′} , {γ}_{2} , {γ}_{2}^{′} , {β}_{2} , {β}_{2}^{′} , … , {γ}_{p - 1} , {γ}_{p - 1}^{′} , {β}_{p - 1} , {β}_{p - 1}^{′} , {γ}_{p} , {γ}_{p}^{′} , {β}_{p} , {β}_{p}^{′} )$$

can be selected randomly. The output quantum states of the measurement operation 1010 can be fed to a classical optimizer and used to evaluate a cost function, which is used to determine updated values of the gate parameters in p layers of the quantum logic circuit 1000

$$\\ ( e . g . , {γ}_{1} , {γ}_{1}^{′} , {β}_{1} , {β}_{1}^{′} , {γ}_{2} , {γ}_{2}^{′} , {β}_{2} , {β}_{2}^{′} , … , {γ}_{p - 1} , {γ}_{p - 1}^{′} , {β}_{p - 1} , {β}_{p - 1}^{′} , {γ}_{p} , {γ}_{p}^{′} , {β}_{p} , {β}_{p}^{′} ) .$$

The quantum logic circuit 1000 at p(p≠0) can be executed with the determined values of the parameters

$$\\ ( e . g . , {H}_{1} , {γ}_{1} , {γ}_{1}^{′} , {β}_{1} , {β}_{1}^{′} , {H}_{2} , {γ}_{2} , {γ}_{2}^{′} , {β}_{2} , {β}_{2}^{′} , … , {H}_{p} , {γ}_{p} , {γ}_{p}^{′} , {β}_{p} , {β}_{p}^{′} ) .$$

In some implementations, the measurement operation 1010 at the end of the quantum logic circuit 1000 with p layers of the circuit portion 1016 can determine values of parameters that can be used to determine the input Hamiltonian (e.g., Hₚ₊₁) to the (p+1)-th layer of the circuit portion 1016 of the example quantum logic circuit 1000.

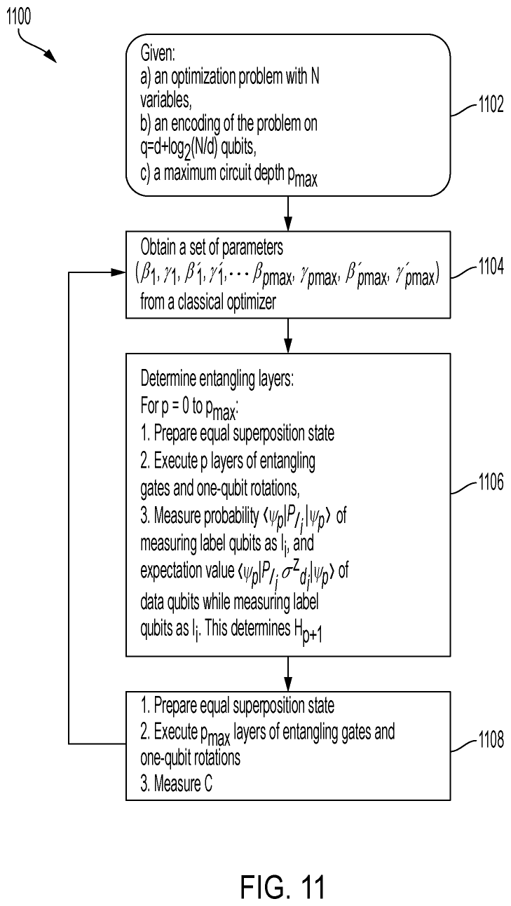

FIG. 11 is a flow chart showing aspects of an example process 1100. In some implementations, the example process 1100 is used to execute the example quantum logic circuit 1000 based on the encoding scheme 200, 600 shown in FIGS. 2 and 6 to minimize a cost function of an optimization problem. The example process 1100 may include additional or different operations, and the operations may be performed in the order shown or in another order. In some cases, operations in the example process 1100 can be combined, iterated or otherwise repeated, or performed in another manner.

At 1102, the number (d) of data qubits is determined based on the optimization problem with N variables. In some instances, the encoding scheme utilizes log₂(N/d) label qubits and d data qubits for a total number of q=d+log₂(N/d) qubits to represent the N variables of the optimization problem. In some cases, the N variables may be divided into N/d groups, each of which may include d variables. In some implementations, a maximum circuit depth of a quantum logic circuit for solving the optimization problem is defined as pₘₐₓ.

At 1104, a set of gate parameters is obtained. In some implementations, the set of gate parameters of the quantum logic gate can be obtained from a classical optimizer determined by minimizing a cost function.

At 1106, input Hamiltonian to the set of entangling gates in the p-th layer can be determined. In some instances, the d data qubits and the log₂(N/d) label qubits can be prepared in the equal superposition state |ψ0 [symbol] . The preparation of the label qubits 1012 and the data qubits 1014 are performed by applying Hadamard gates 1002 on the label qubits 1012 and data qubits 1014. An initial value of p is set to 0. For example, at p=0, the probability [symbol] ψ₀|Pₗ_{ᵢ}|ψ₀ [symbol] of measuring label qubits as lᵢ and the expectation values

$$\\ 〈 {ψ}_{0} \vert {P}_{{l}_{i}} {σ}_{{d}_{i}}^{z} \vert {ψ}_{0} 〉$$

of data qubits while measuring the label qubits as lᵢ are computed based on measured output quantum states by performing the measurement operation 1010 shown in FIG. 10. In some instances, the input Hamiltonian (e.g., H₁) to the entangling gates in the next p=1 layer of the circuit portion 1016 can be determined according to Equation (8).

At 1108, the d data qubits and the log₂(N/d) label qubits are prepared in the equal superposition state |ψ₀ [symbol] . The set of entangling gates are executed. In some implementations, each entangling gate generates entanglement across pairs of qubit devices 222, 224 that are coupled by respective coupler devices 226. At p=1, the initial value of the gate parameters γ₁ can be randomly chosen; and the input Hamiltonian H₁ is determined from the execution of the quantum logic circuit at p=0. The single-qubit rotation gates are then applied. At p=1, the initial values of the gate parameter.

$$\\ ( {γ}_{1}^{′} , {β}_{1} , {β}_{1}^{′} )$$

may be randomly chosen. In some implementations, the single-qubit rotation gates include single-qubit Z-rotation gates applied on the data qubits 1014; and single-qubit X-rotation gates applied on the data and label qubits 1014, 1012. In some instances, a cost function can be evaluated based on the measured output quantum states. The output quantum states of the measurement operation can be fed to a classical optimizer and used to evaluate the cost function, which is used to determine updated gate parameters of the quantum logic circuits. The quantum evolution during the operation 1108 can be repeated multiple times and the values of the gate parameters can be updated multiple times until convergence or if a set of termination criteria is met. In some instances, the best values of the gate parameters are determined, for example, by minimizing the cost function. The quantum logic circuit with the parameters

$$\\ ( e . g . , {H}_{1} , {γ}_{1} , {γ}_{1}^{′} , {β}_{1} , {β}_{1}^{′} )$$

set at the determined values can be executed; and the output quantum state can be measured. At p=1, the probability [symbol] ψ₀|Pₗ_{ᵢ}|ψ₀ [symbol] of measuring label qubits as lᵢ and the expectation values

$$\\ 〈 {ψ}_{0} \vert {P}_{{l}_{i}} {σ}_{{d}_{i}}^{z} \vert {ψ}_{0} 〉$$

of data qubits while measuring the label qubits as lᵢ can then be computed based on the measured output quantum states. In some instances, the input Hamiltonian (e.g., H₂) to the entangling gates in the next p=2 layer of the circuit portion 1016 can be determined according to Equation (8).

In some implementations, p can be increased by 1; and operations of the process 1100 can be repeated. For example, at p=2, the two sets of entangling gates receive the previously determined input Hamiltonian (e.g., H₁ and H₂); and the quantum logic circuit is executed (e.g., operation 1108). The best values of the gate parameters

$$\\ ( e . g . , {γ}_{1} , {γ}_{1}^{′} , {β}_{1} , {β}_{1}^{′} , {γ}_{2} , {γ}_{2}^{′} , {β}_{2} , {β}_{2}^{′} )$$

can be determined by operation of the classical optimizer, for example, by minimizing a cost function (e.g., operation 1104). The quantum logic circuit with the parameters

$$\\ ( e . g . , {H}_{1} , {γ}_{1} , {γ}_{1}^{′} , {β}_{1} , {β}_{1}^{′} , {H}_{2} , {γ}_{2} , {γ}_{2}^{′} , {β}_{2} , {β}_{2}^{′} )$$

set at the determined values are executed; and the output quantum states are measured. The input Hamiltonian (e.g., H₃) to the third layer (e.g., operation 1106) can then be determined based on the output quantum state from the measurement operation. In some implementations, the process 1100 is an iterative process until p=pₘₐₓ.

For the quantum logic circuit 1000 including p layers of the circuit portion 1016, there is a provable performance guarantee at any value of p. In some implementations, the value of the cost function C produced by the example quantum logic circuit 1000 at any value of p is upper-bounded by

$$\\ \begin{matrix}C ( p ) \leq {c}_{1} ( p ; {z}_{1} , . . {z}_{d} ) + {c}_{2} ( p ; {z}_{d + 1} , . . {z}_{2 d} ) + {c}_{\frac{N}{d}} ( p ; {z}_{N - d + 1} . . {z}_{N} ) , & ( 9 )\end{matrix}$$

where cᵢ(p; \vec{z}) is the cost produced in the binary encoding (e.g., the d variables are encoded in d qubits) for a subproblem with only the variables (z_{(i-1)d+1} . . . z_{id}) from the original problem, after p layers of the circuit portion 1016 shown in FIG. 10. For the case of Sherrington-Kirkpatrick (SK) models, which have random values of wᵢⱼ, the approximation ratio r=C/Cₘᵢₙ produced by the quantum logic circuit 1000 at any value of p is lower-bounded by

$$\\ \begin{matrix}r ( p ) \geq {r}_{binary} ( p ) \sqrt{\frac{N}{d}} , & ( 10 )\end{matrix}$$

where r_{binary} is the approximation ratio produced with the binary encoding (N=d).

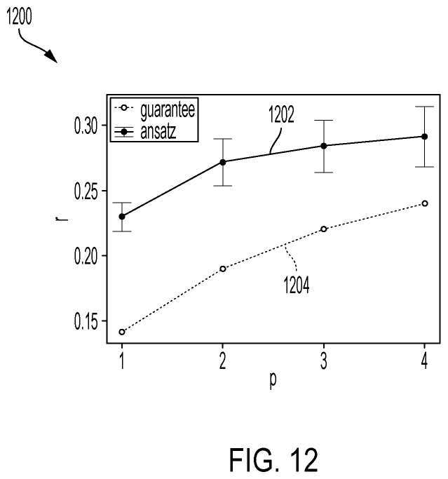

FIG. 12 is a plot 1200 showing the average approximation ratio (r) as a function of the number of layers (p) of the circuit portion 1016 shown in FIG. 10. The approximation ratio is averaged over 5 SK model problem instances with a total number of variables N=64 encoded on d=8 data qubits. Curve 1204 represents the average approximation ratio under the performance guarantee. Curve 1202 represents the average approximation ratio under the performance of the variational ansatz shown in FIG. 10.

For p layers of the circuit portion 1016 in the quantum logic circuit 1000 shown in FIG. 10, the optimal solution exists as p→∞; and the values of the parameters required associated with the optimal solution at p→∞ are known. In some implementations, setting the values

$$\\ {β}^{′} = β , {γ}^{′} \to 0 , γ = dt \frac{p}{{p}_{max}} , β = dt ( 1 - \frac{p}{{p}_{max}} ) , dt \to 0 ,$$

the approximation ratio at Pₘₐₓ→∞ is r=1. Such evolution is called adiabatic evolution, which motivates the variational ansatz shown in FIG. 10.

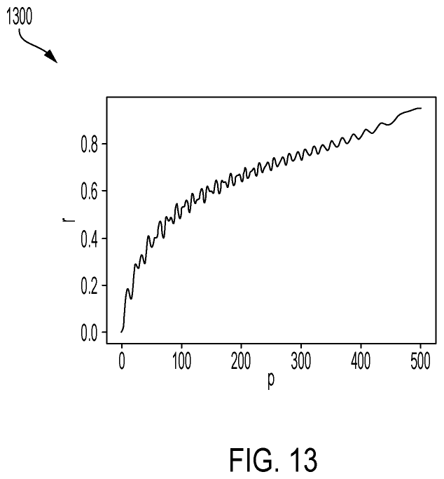

FIG. 13 is a plot 1300 showing the approximation ratio as a function of the number of layers p of the circuit portion 1016 shown in FIG. 10. The approximation ratio approaches 1 under adiabatic evolution for SK model using the encoding scheme shown in FIG. 2 for an optimization problem by encoding N=20 variables on d=10 data qubits.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

In a general aspect, hardware-efficient encoding schemes for optimization problems are presented.

In a first example, a quantum computing method includes associating subsets of qubits with clusters of variables in an optimization problem. Each subset of qubits includes data qubits and label qubits. The method includes mapping the variables in each cluster to the data qubits associated with the cluster, such that multiple variables are mapped to each of the data qubits. Mapping the variables in each cluster includes identifying basis states of the label qubits associated with the cluster; dividing the cluster into groups of variables, each group of variables being associated with a respective one of the basis states; and for each group of variables, mapping each variable in the group to a respective one of the data qubits associated with the cluster. The method includes causing a quantum processing unit to execute multiple iterations of a quantum program. Each iteration includes preparing each subset of qubits in an entangled state by executing a first portion of a quantum logic circuit; applying a second portion of a quantum logic circuit to each subset of qubits; and obtaining measurements of the subsets of qubits. The second portion of the quantum logic circuit corresponds to the optimization problem. The measurement of each subset includes measured states of the data qubits in the subset and measured states of the label qubits in the subset. The method further includes processing the measurements and generating a solution to the optimization problem based on the processed measurements. Processing the measurements includes determining, for each measurement, which variables are represented by the measured states of the data qubits according to the measured states of the label qubits.

Implementations of the first example may include one or more of the following features. Associating the subsets of qubits with the clusters of variables in an optimization problem includes dividing the variables into a first number (n) of clusters, each cluster comprising N/n variables, where N is the number of the variables; dividing the N/n variables in each cluster into a second number (N/nd) of groups; and dividing qubits in the quantum processing units into n subsets, each subset comprising a third number of data qubits (d) and a fourth number

$$\\ ( {log}_{2} ( \frac{N}{n} / d ) )$$

of label qubits. Causing a quantum processing unit to execute multiple iterations of a quantum program includes determining the quantum logic circuit defined over the third number of data qubits and the fourth number of label qubits in each subset, the first circuit portion of the quantum logic circuit comprises a first set of single-qubit quantum logic gates applied on the third number of data quits and the fourth number of label qubits of each subset, and a second set of two-qubit quantum logic gates applied to respective pairs of qubits of each subset. The single-qubit quantum logic gates include Hadamard gates applied on the third number of data qubits and the fourth number of label qubits in each subset.

Implementations of the first example may include one or more of the following features. The first circuit portion of the quantum logic circuit includes at least one layer of multi-qubit quantum logic gates comprising at least one two-qubit quantum logic gate defined over a respective data qubit and a label qubit. Processing the measurements outputs average values of the variables defined by the measured states of the data qubits and the measured states of the label qubits in the associated subset.

Implementations of the first example may include one or more of the following features. The method includes evaluating a cost function based on the measured states to determine updated values of gate parameters of the quantum logic circuit. Preparing each subset of qubits in an entangled state includes preparing each subset of qubits in a target coherent superposition state.

In a second example, a computer system includes a quantum processing unit and a classical processing unit configured to perform operations in the first example.

In a third example, a quantum computing method includes causing a quantum processing unit to execute multiple iterations of a quantum program. Each iteration includes executing a first portion of one or more quantum logic circuits, executing a second portion of the one or more quantum logic circuits, and obtaining measurements of the subsets of qubits after applying the first and second portions of the one or more quantum logic circuits. The first portion is applied to a plurality of qubits comprising subsets of qubits. Each subset of qubits is associated with a respective cluster of variables in an optimization problem and includes data qubits and label qubits. Each cluster of variables includes groups of variables. The second portion is applied to the qubits and corresponds to the optimization problem. The measurement of each subset includes measured states of the data qubits in the subset and measured states of the label qubits in the subset. The method includes processing the measurements which includes determining, for each measurement, a group of variables in each cluster represented by the measured states of the data qubits in a subset associated with the cluster according to the measured states of the label qubits in the subset associated with the cluster; and generating a solution to the optimization problem based on the processed measurements.

Implementations of the third example may include one or more of the following features. The first circuit portion of the one or more quantum logic circuits includes at least one layer of multi-qubit quantum logic gates which includes at least one two-qubit quantum logic gate defined over a respective data qubit and a label qubit. Processing the measurements outputs average values of the variables defined by the measured states of the data qubits and the measured states of the label qubits. The method further includes evaluating a cost function based on the measured states to determine updated values of the parameters of the one or more quantum logic circuits. Executing the first portion of the one or more quantum logic circuits includes preparing each subset of qubits in a target coherent superposition state.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A quantum computing method comprising:
associating subsets of qubits with clusters of variables in an optimization problem, wherein each subset of qubits comprises data qubits and label qubits;
performing a mapping process to map the variables in each cluster to the data qubits associated with the cluster, such that multiple variables are mapped to each of the data qubits, wherein performing the mapping process comprises:
identifying basis states of the label qubits associated with the cluster;
dividing the cluster into groups of variables, each group of variables being associated with a respective one of the basis states; and
for each group of variables, mapping each variable in the group to a respective one of the data qubits associated with the cluster; and
causing a quantum processing unit to execute multiple iterations of a quantum program, wherein each iteration comprises:
preparing each subset of qubits in an entangled state by executing a first portion of one or more quantum logic circuits;
applying a second portion of the one or more quantum logic circuits to each subset of qubits, wherein the second portion of the one or more quantum logic circuits corresponds to the optimization problem; and
obtaining measurements of the subsets of qubits, wherein the measurement of each subset comprises measured states of the data qubits in the subset and measured states of the label qubits in the subset;
processing the measurements, wherein processing the measurements comprises determining, for each measurement, which variables are represented by the measured states of the data qubits according to the measured states of the label qubits; and
generating a solution to the optimization problem based on the processed measurements.

2. The method of claim 1, wherein associating the subsets of qubits with the clusters of variables in an optimization problem comprises:
dividing the variables into a first number (n) of clusters, each cluster comprising N/n variables, wherein N is the number of the variables;
dividing the N/n variables in each cluster into a second number (N/nd) of groups; and
dividing qubits in the quantum processing units into n subsets, each subset comprising a third number of data qubits (d) and a fourth number
$$\\ ( {log}_{2} ( \frac{N}{n} / d ) )$$
of label qubits.

3. The method of claim 2, wherein causing a quantum processing unit to execute multiple iterations of a quantum program comprises:
determining the one or more quantum logic circuits defined over the third number of data qubits and the fourth number of label qubits in each subset, the first circuit portion of the one or more quantum logic circuits comprises a first set of single-qubit quantum logic gates applied on the third number of data quits and the fourth number of label qubits of a subset, and a second set of two-qubit quantum logic gates applied to respective pairs of qubits of the subset.

4. The method of claim 3, wherein the single-qubit quantum logic gates comprise Hadamard gates applied on the third number of data qubits and the fourth number of label qubits in each subset.

5. The method of claim 1, wherein the first circuit portion of the one or more quantum logic circuits comprises at least one layer of multi-qubit quantum logic gates comprising at least one two-qubit quantum logic gate defined over a respective data qubit and a label qubit.

6. The method of claim 1, wherein processing the measurements outputs average values of the variables defined by the measured states of the data qubits and the measured states of the label qubits.

7. The method of claim 1, comprising:
evaluating a cost function based on the measured states to determine updated values of the parameters of the one or more quantum logic circuits.

8. The method of claim 1, wherein preparing each subset of qubits in an entangled state comprises:
preparing each subset of qubits in a target coherent superposition state.

9. A computer system comprising:
a quantum processing unit; and
a classical processing unit configured to:
associate subsets of qubits with clusters of variables in an optimization problem, wherein each subset of qubits comprises data qubits and label qubits;
map the variables in each cluster to the data qubits associated with the cluster, such that multiple variables are mapped to each of the data qubits, wherein mapping the variables in each cluster comprises:
identifying basis states of the label qubits associated with the cluster;
dividing the cluster into groups of variables, each group of variables being associated with a respective one of the basis states; and
for each group of variables, mapping each variable in the group to a respective one of the data qubits associated with the cluster; and
cause the quantum processing unit to execute multiple iterations of a quantum program, wherein each iteration comprises:
preparing each subset of qubits in an entangled state by executing a first portion of one or more quantum logic circuits;
applying a second portion of the one or more quantum logic circuits to each subset of qubits, wherein the second portion of the quantum logic circuit corresponds to the optimization problem; and
obtaining measurements of the subsets of qubits, wherein the measurement of each subset comprises measured states of the data qubits in the subset and measured states of the label qubits in the subset;
process the measurements, wherein processing the measurements comprises determining, for each measurement, which variables are represented by the measured states of the data qubits according to the measured states of the label qubits; and
generate a solution to the optimization problem based on the processed measurements.

10. The computer system of claim 9, wherein associating the subsets of qubits with the clusters of variables in an optimization problem comprises:
dividing the variables into a first number (n) of clusters, each cluster comprising N/n variables, wherein N is the number of the variables;
dividing the N/n variables in each cluster into a second number (N/nd) of groups; and
dividing qubits in the quantum processing units into n subsets, each subset comprising a third number of data qubits (d) and a fourth number
$$\\ ( {log}_{2} ( \frac{N}{n} / d ) )$$
of label qubits.

11. The computer system of claim 10, wherein causing a quantum processing unit to execute multiple iterations of a quantum program comprises:
determining the one or more quantum logic circuits defined over the third number of data qubits and the fourth number of label qubits in each subset, the first circuit portion of the one or more quantum logic circuits comprises a first set of single-qubit quantum logic gates applied on the third number of data quits and the fourth number of label qubits of a subset, and a second set of two-qubit quantum logic gates applied to respective pairs of qubits of the subset.

12. The computer system of claim 9, wherein the single-qubit quantum logic gates comprise Hadamard gates applied on the third number of data qubits and the fourth number of label qubits in each subset.

13. The computer system of claim 9, wherein the first circuit portion of the one or more quantum logic circuits comprises at least one layer of multi-qubit quantum logic gates comprising at least one two-qubit quantum logic gate defined over a respective data qubit and a label qubit.

14. The computer system of claim 9, wherein processing the measurements outputs average values of the variables defined by the measured states of the data qubits and the measured states of the label qubits.

15. The computer system of claim 9, wherein the classical processing unit is configured to:
evaluate a cost function based on the measured states to determine updated values of the parameters of the one or more quantum logic circuits.

16. The computer system of claim 9, wherein preparing each subset of qubits in an entangled state comprises:
preparing each subset of qubits in a target coherent superposition state.

17. A quantum computing method comprising:
causing a quantum processing unit to execute multiple iterations of a quantum program, wherein each iteration comprises:
executing a first portion of one or more quantum logic circuits, wherein the first portion is applied to a plurality of qubits comprising subsets of qubits, each subset of qubits being associated with a respective cluster of variables in an optimization problem and comprising data qubits and label qubits, each cluster of variables comprising groups of variables;
executing a second portion of the one or more quantum logic circuits, wherein the second portion is applied to the qubits and corresponds to the optimization problem; and
obtaining measurements of the subsets of qubits after applying the first and second portions of the one or more quantum logic circuits, wherein the measurement of each subset comprises measured states of the data qubits in the subset and measured states of the label qubits in the subset;
processing the measurements, wherein processing the measurements comprises determining, for each measurement, a group of variables in each cluster represented by the measured states of the data qubits in a subset associated with the cluster according to the measured states of the label qubits in the subset associated with the cluster; and
generating a solution to the optimization problem based on the processed measurements.

18. The method of claim 17, wherein the first circuit portion of the one or more quantum logic circuits comprises at least one layer of multi-qubit quantum logic gates comprising at least one two-qubit quantum logic gate defined over a respective data qubit and a label qubit.

19. The method of claim 17, wherein processing the measurements outputs average values of the variables defined by the measured states of the data qubits and the measured states of the label qubits.

20. The method of claim 17, comprising:
evaluating a cost function based on the measured states to determine updated values of the parameters of the one or more quantum logic circuits.

21. The method of claim 17, wherein executing the first portion of the one or more quantum logic circuits comprises:
preparing each subset of qubits in a target coherent superposition state.
